(19) United States
(12) Patent Application Publication
(10) Pub. No.: US 2024/0147438 A1
(43) Pub. Date: May 2, 2024

(54) TIME DOMAIN RESOURCE ALLOCATION FOR DATA TRANSMISSIONS

(71) Applicant: Intel Corporation, Santa Clara, CA (US)

(72) Inventors: Gang Xiong, Portland, OR (US); Bishwarup Mondal, San Ramon, CA (US); Yingyang Li, Beijing (CN); Gregory Morozov, Nizhny Novgorod (RU); Daewon Lee, Portland, OR (US)

(21) Appl. No.: 18/548,330

(22) PCT Filed: Mar. 9, 2022
(86) PCT No.: PCT/US2022/019610

§ 371 Date: Aug. 29, 2023

Related U.S. Application Data
(60) Provisional application No. 63/160,589, filed on Mar. 12, 2021.
(60) Provisional application No. 63/168,785, filed on Mar. 31, 2021.

(51) Int. Cl. H04W 72/0446; H04W 72/12

(52) U.S. Cl. CPC H04W 72/0446; H04W 72/12

(57) ABSTRACT

Various embodiments herein are directed to time domain resource allocation for data transmissions. An apparatus may comprise: memory to store time domain resource allocation (TDRA) information associated with data transmission; and processing circuitry, coupled with the memory, to: retrieve the TDRA information from the memory, wherein the TDRA information includes a plurality of TDRA parameters that are independently configured for different scheduled data transmissions; and encode a message for transmission to a user equipment (UE) that includes the TDRA information. Other embodiments may be disclosed or claimed.

### CROSS REFERENCE TO RELATED APPLICATION

The present application claims priority to U.S. Provisional Patent Application No. 63/160,589, which was filed Mar. 12, 2021; and to U.S. Provisional Patent Application No. 63/168,785, which was filed Mar. 31, 2021.

### FIELD

Various embodiments generally may relate to the field of wireless communications. For example, some embodiments may relate to time domain resource allocation for data transmissions.

### BACKGROUND

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is exapected to be a unified network/system that target to meet vastly different and somtime conflicting performance dimensions and services. Such diverse mult-dimensional requirements are driven by different services and applications. In general, NR will evolve based on 3GPP LTE-Advanced with additional potential new Radio Access Technologies (RATs) to enrish people lives with better, simple, and seamless wireless connectivity solutions. NR will enable everything connected by wireless and deliver fast, rich content and services.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings. [TO DO]

FIG. 1 illustrates an example of multi-TTI scheduling for PDSCHs in accordance with various embodiments.

FIG. 2 illustrates an example of Multi-PDSCH scheduling with mult-TRP operation embodiments.

FIG. 3 illustrates and example of Multi-PDSCH scheduling with mult-TRP operation TDM scheme A in accordance with various embodiments.

FIG. 4 illustrates and example of Multi-PDSCH scheduling with multi-TRP operation: Option 1 in accordance with various embodiments.

FIG. 5 illustrates an example of Multi-PDSCH scheduling with multi-TRP operation: Option 2 in accordance with various embodiments.

FIG. 6 illustrates an example of Multi-PUSCH scheduling with multi-TRP operation for PUSCH with repetition type B in accordance with various embodiments.

FIG. 7 illustrates an example of Example of multi-PDSCH scheduling with multiple UEs scheduling by the same DCI in accordance with various embodiments.

FIG. 8 illustrates an example of Single PDSCH scheduling in accordance with various embodiments.

FIG. 9 illustrates an example of Single PDSCH with a TB spanning more than one slot in accordance with various embodiments.

FIG. 10 illustrates an example of Multi-PDSCH scheduling with repetition for each PDSCH in accordance with various embodiments.

FIG. 11 illustrates an example of Multi-PDSCH scheduling with each PDSCH with a TB spanning more than one slot in accordance with various embodiments.

FIG. 12 illustrates an example of Different SLIVs for single PDSCH with repetitions in accordance with various embodiments.

FIG. 13 illustrates an example of Different SLIVs and number of repetitions for scheduled PDSCHs in accordance with various embodiments.

FIG. 14 schematically illustrates a wireless network in accordance with various embodiments.

FIG. 15 schematically illustrates components of a wireless network in accordance with various embodiments.

FIG. 16 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 17, 18, and 19 depict examples of procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

For 5G systems, high frequency band communication has attracted significant attention from the industry, since it can provide wider bandwidth to support the future integrated communication system. The beam forming is an important technology for the implementation of high frequency band system due to the fact that the beam forming gain can compensate the severe path loss caused by atmospheric attenuation, improve the SNR, and enlarge the coverage area. By aligning the transmission beam to the target UE, radiated energy is focused for higher energy efficiency, and mutual UE interference is suppressed.

As defined in NR, one slot has 14 symbols. For systems operating above 52.6 GHz carrier frequency, when larger subcarrier spacing, e.g., 480 kHz or 960 kHz is employed, slot duration can be very short. For instance, for 960 kHz subcarrier spacing, one slot duration is approximately 15.6 μs. This extremely short slot duration may not be sufficient for the processing of higher layer, including MAC and RLC, etc. In this case, certain mechanisms may need to be defined to allow long transmission duration and adequate processing time for higher layer.

To address this issue, multi-Transmission Time Interval (TTI) based scheduling can be employed, where one physical downlink control channel (PDCCH) can be used to schedule multiple physical downlink shared channel (PDSCH) or physical uplink shared channel (PUSCH) carrying independent transport block (TBs). Based on this mechanism, scheduler implementation and higher layer processing burdened can be relaxed, while maintaining same peak data rate.

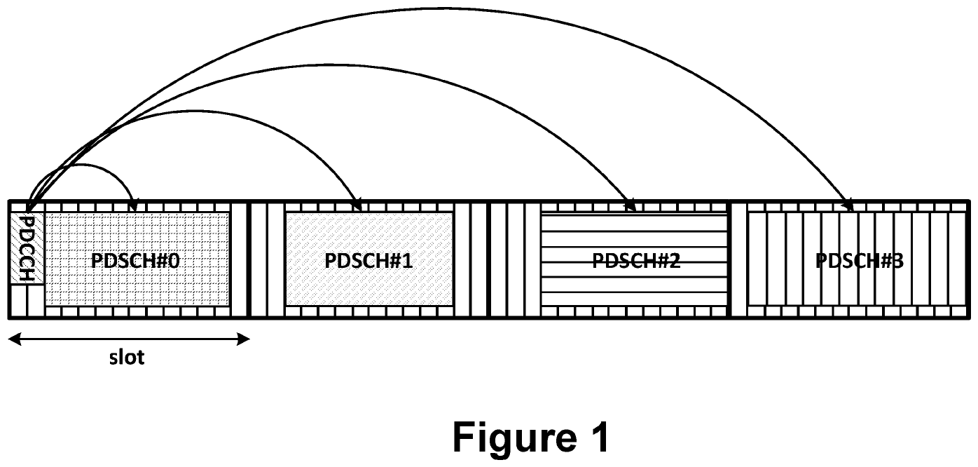

FIG. 1 illustrates one example of multi-TTI scheduling for PDSCHs. In this example, four PDSCHs (PDSCH #0-3) with different transport blocks (TB) are scheduled by a single DCI. Note that although in the figure, different time domain resource allocation is allocated for different PDSCHs in different slots, the design can be extended to the case when same time domain resource allocation is allocated for PDSCH transmissions.

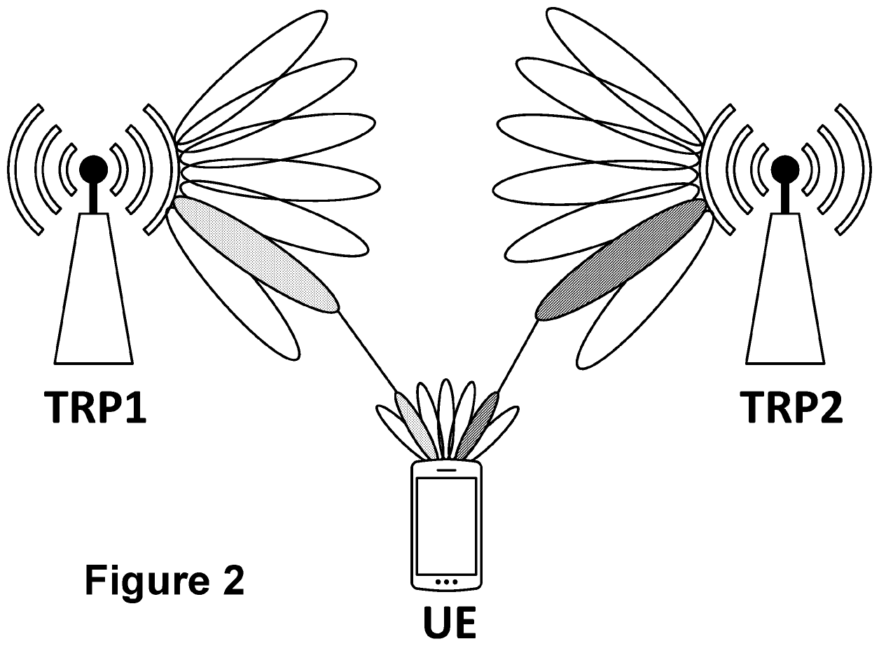

In NR, multiple transmit and receive points (TRP)s can be utilized to transmit and receive data and control channel, which can help in improving the reliability for communication. FIG. 2 illustrates one example of multi-TRP operation. Note that when multi-TTI scheduling for PDSCH and PUSCH transmission is employed with multi-TRP operation, certain design aspects may need to be considered.

Among other things, embodiments of the present disclosure are directed to multi-PDSCH and multi-PUSCH scheduling for multi-TRP operation for systems operating above 52.6 GHz carrier frequency. In particular, some embodiments are directed to:
multi-PDSCH scheduling under multi-TRP operation
multi-PUSCH scheduling under multi-TRP operation
Scheduling of multi-PDSCH/PUSCH transmissions using a single DCI.

### Multi-PDSCH Scheduling Under Multi-TRP Operation

As mentioned above, for systems operating above the 52.6 GHz carrier frequency, when larger subcarrier spacing, e.g., 480 kHz or 960 kHz is employed, slot duration can be very short. For instance, for 960 kHz subcarrier spacing, one slot duration is approximately 15.6 μs. This extremely short slot duration may not be sufficient for the processing of higher layer, including MAC and RLC, etc. In this case, certain mechanisms may need to be defined to allow long transmission duration and adequate processing time for higher layer.

To address this issue, multi-TTI based scheduling can be employed, where one PDCCH can be used to schedule multiple PDSCHs or PUSCH carrying independent TBs. Based on this mechanism, scheduler implementation and higher layer processing burdened can be relaxed, while maintaining same peak data rate.

In NR, multiple transmit and receive points (TRP)s can be utilized to transmit and receive data and control channel, which can help in improving the reliability for communication. Note that when multi-TTI scheduling for PDSCH and PUSCH transmission is employed with multi-TRP operation, certain design aspects may need to be considered.

Embodiments for multi-PDSCH scheduling under multi-TRP operation are provided as follows:

In one embodiment, for FDM-based schemes (e.g., FDM schemes A and B), the same frequency domain resource allocation (FDRA) is allocated for all scheduled PDSCHs for different TRPs in case when multi-PDSCH scheduling is applied. More specifically, when for a UE configured by the higher layer parameter RepSchemeEnabler set to ‘FDMSchemeA’ or ‘FDMSchemeB’, and when the UE is indicated with two TCI states in a codepoint of the DCI field ‘Transmission Configuration Indication and DM-RS port(s) within one CDM group in the DCI field “Antenna Port(s)”, FDRA can be applied for all scheduled PDSCHs.

In another embodiment, when multi-PDSCH scheduling is applied for TDM scheme A for multi-TRP operation, two repetitions in a slot are applied for all the scheduled PDSCHs, where different TRPs or TCI states are applied for each repetition of a PDSCH. In particular, if two TCI states are indicated by the DCI field ‘Transmission Configuration Indication’, a first TCI state is applied for a first transmission occasion of a PDSCH with all the scheduled PDSCHs, where a second TCI state is applied for a second transmission occasion of the PDSCH.

In addition, the same number of symbols are applied for the first and second transmission occasions for a PDSCH for multi-PDSCH scheduling. Further, same or different starting symbol offsets may be applied for the last symbol of the first transmission occasions and first symbol of the second transmission occasions. Note that depending on the TDRA configuration, different SLIV may be allocated for different PDSCHs in case of multi-PDSCH scheduling.

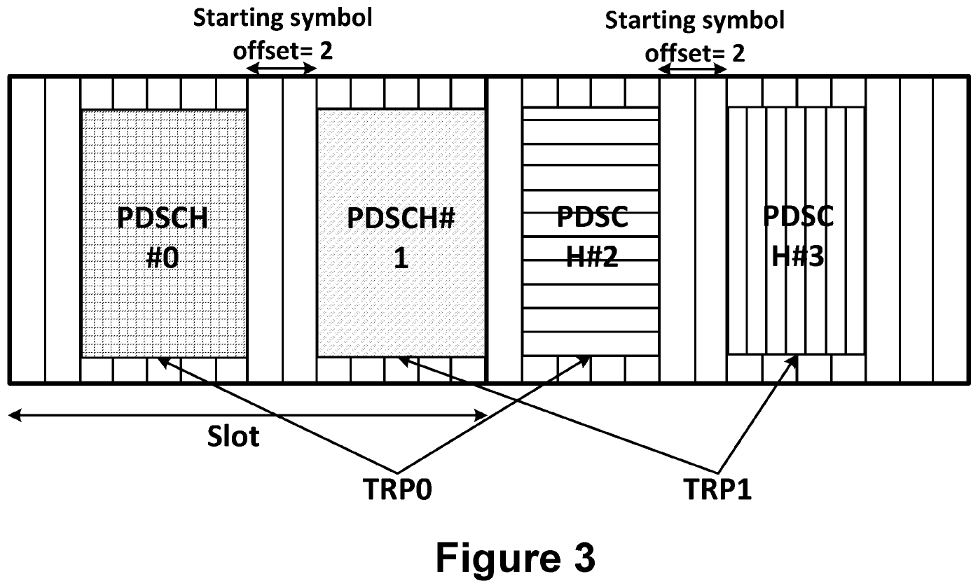

FIG. 3 illustrates one example of multi-PDSCH scheduling with multi-TRP operation TDM scheme A. In the example, two PDSCHs are scheduled by a single DCI. Further, same number of symbols is allocated for the two PDSCHs, respectively and starting symbol offset is 2 for the two PDSCHs. For TDM scheme A, a first and second TCI state (TRP #0 and #1, respectively) is applied for a first and second transmission occasion of a first PDSCH, followed by the first and second TCI state for a first and second transmission occasion of a second PDSCH.

In another embodiment, for multi-PDSCH scheduling, when repetitions are applied for the transmission of scheduled PDSCHs, different beams can be applied for all the scheduled PDSCHs in different transmission occasions.

Note that for repetition of each PDSCH, same time domain resource allocation may be applied. In one example, same start and length indicator value (SLIV) can be applied for the repetition of a PDSCH in case of multi-PDSCH scheduling.

In one option, when two TCI states are indicated by the DCI field ‘Transmission Configuration Indication’ for multi-PDSCH scheduling, a first TCI state is applied for a first transmission occasions of all the scheduled PDSCHs, followed by a second TCI state for a second transmission occasions of all the scheduled PDSCHs.

Further, when more than 2 repetitions are used for the transmission of PDSCHs, either cyclic beam mapping or sequential beam mapping can be applied as defined in Rel-16. In this case, beam cycling pattern is applied for all the scheduled PDSCHs.

In particular, when cyclic mapping is enabled, the first and second TCI states are applied to the first and second transmission occasions for all the scheduled PDSCHs, respectively, and the same TCI mapping pattern continues to the remaining transmission occasions for all the scheduled PDSCHs. In addition, when sequential mapping is enabled, first TCI state is applied to the first and second transmissions for all the scheduled PDSCHs, and the second TCI state is applied to the third and fourth transmissions for all the scheduled PDSCHs, and the same TCI mapping pattern continues to the remaining transmission occasions of all the scheduled PDSCHs.

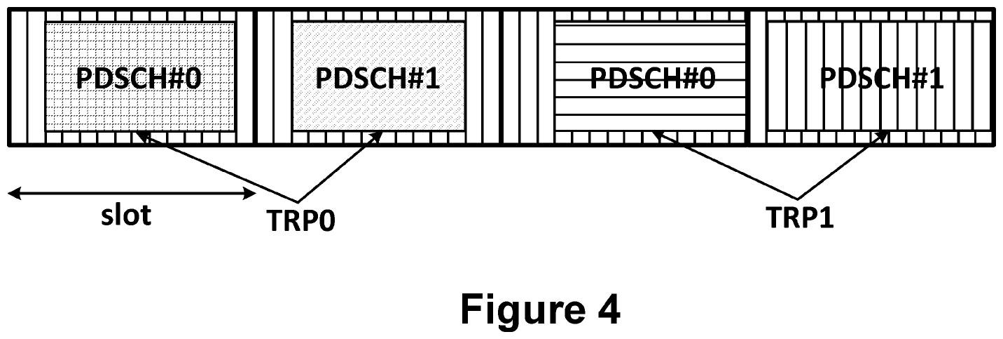

FIG. 4 illustrates one example of multi-PDSCH scheduling with multi-TRP operation. In this example, two PDSCHs are scheduled by a single DCI and each PDSCH has two repetitions. Based on this option, the first TCI state (or TRP #0) is applied for a first transmission occasion of a first PDSCH, followed by the first TCI state for a first transmission occasion of a second PDSCH, then the second TCI state (or TRP #1) for the second transmission of the first PDSCH, then the second TCI state for the second transmission occasion of the second PDSCH.

In another option, when two TCI states are indicated by the DCI field ‘Transmission Configuration Indication’ for multi-PDSCH scheduling, a first and second TCI states are applied for repetitions of a first PDSCH, followed by the first and second TCI state for repetitions of a second PDSCH. Within the repetitions of PDSCHs, either cyclic beam mapping pattern or sequential beam mapping pattern as mentioned above can be applied.

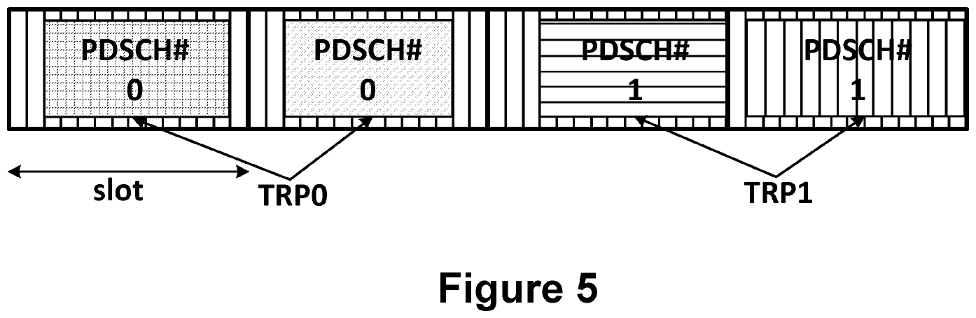

FIG. 5 illustrates one example of multi-PDSCH scheduling with multi-TRP operation. In this example, two PDSCHs are scheduled by a single DCI and each PDSCH has two repetitions. Based on this option, a first TCI state (or TRP #0) is applied for a first transmission occasion of a first PDSCH, followed by a second TCI state (or TRP #1) for a second transmission occasion of the first PDSCH, then the first TCI state for the first transmission of the second PDSCH, then the second TCI state for the second transmission occasion of the second PDSCH.

### Multi-PUSCH Scheduling Under Multi-TRP Operation

Embodiments of multi-PUSCH scheduling under multi-TRP operation are provided as follows:

In one embodiment, for PUSCH repetition type A, when repetitions are applied for the transmission of scheduled PUSCHs in case when multi-PUSCH scheduling is applied, different beams can be applied for all the scheduled PUSCHs in different transmission occasions. Further, same mechanisms as mentioned above when repetitions are applied for the transmission of scheduled PDSCHs can be applied for PUSCH repetition type A. For instance, in the FIGS. 4 and FIG. 5, PDSCH can be replaced by PUSCH, which can be applied for the PUSCH repetition type A in case of multi-PUSCH scheduling.

In another embodiment, for PUSCH repetition type B, when two sounding reference signal resource indicators (SRI) are indicated or configured in the DCI for multi-PUSCH scheduling, a first and second SRI states are applied for nominal repetitions of a first PUSCH, followed by the first and second SRI state for nominal repetitions of a second PUSCH. Within the nominal repetitions of PUSCHs, either cyclic beam mapping pattern or sequential beam mapping pattern as mentioned above can be applied.

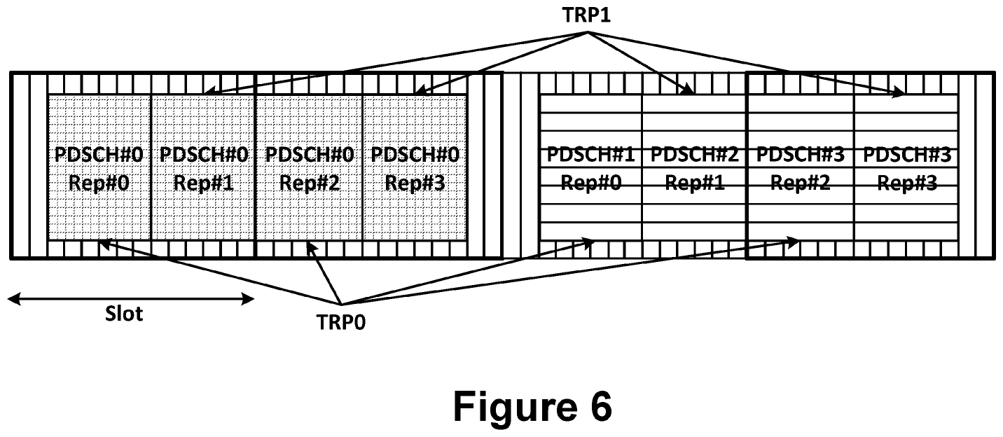

FIG. 6 illustrates one example of multi-PUSCH scheduling with multi-TRP operation for PUSCH with repetition type B. In the example, two PUSCHs with repetition type B are scheduled by a single DCI and each PUSCH has four repetitions. Based on this option, a first SRI state (or TRP #0) is applied for a first and third nominal repetition of a first PUSCH and a first and third nominal repetition of a second PUSCH; while a second SRI state (or TRP #1) is applied for a second and fourth nominal repetition of a first PUSCH and a second and fourth nominal repetition of a second PUSCH;

In another embodiment, in Rel-16 multi-PUSCH scheduling, when two PUSCHs are scheduled by a DCI, aperiodic channel state information (A-CSI) is transmitted on the last PUSCH. Further, when more than two PUSCHs are scheduled by a DCI, A-CSI is transmitted on the penultimate (second last) scheduled PUSCH.

In case of multi-TRP operation, if a PUSCH is repeated two times and respectively transmitted for the two TRPs, A-CSI is transmitted on both the two repetitions of the PUSCHs using two beams, respectively. Further, if a PUSCH is repeated N (N≥2) times and transmitted to the two TRPs, A-CSI is transmitted on the first and second repetition of the PUSCH using the two beams respectively. Alternatively, if a PUSCH is repeated N (N≥2) times and transmitted to the two TRPs, A-CSI is transmitted on the all N repetitions of the PUSCH using two beams based on the beam cycling pattern for PUSCH transmission.

In case of multi-TRP operation, when PUSCH repetition type A is applied for multi-PUSCH scheduling, A-CSI is transmitted on the first repetition of the penultimate scheduled PUSCH using a first beam while A-CSI is transmitted on the second repetition of the penultimate scheduled PUSCH using a second beam.

Further, in case of multi-TRP operation, when PUSCH repetition type B is applied for multi-PUSCH scheduling, A-CSI is transmitted on the first actual repetition of the penultimate scheduled PUSCH using a first beam, while A-CSI is transmitted on the X-th actual repetition of the penultimate scheduled PUSCH using a second beam, where first actual repetition has same number of symbols as the X actual repetition. Note that the UE does not expect the first actual repetition corresponding to the first beam and the X-th actual repetition corresponding to the second beam to have a single symbol duration

### Scheduling of Multi-PDSCH/PUSCH Transmission Using a Single DCI

Embodiments of scheduling of multi-PDSCH/PUSCH transmission using a single DCI are provided as follows:

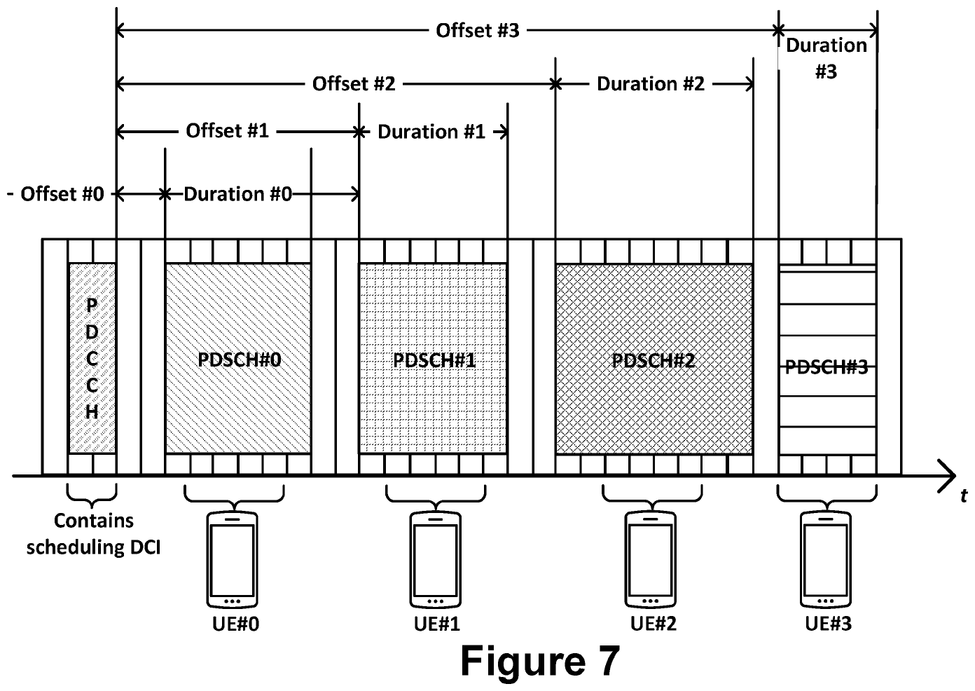

In one embodiment, to reduce the overhead of multiple PDCCH transmissions with scheduling DCIs for different UEs, a single DCI can be used to schedule a group of UEs simultaneously for multiple PDSCHs or PUSCHs. In this case, the UE, upon reception of scheduling DCI, identifies a set of parameters indicating its PDSCH/PUSCH transmission. In some embodiments, this set of parameters includes a duration of PDSCH/PUSCH transmission and offset from the scheduling DCI for each scheduled UE as illustrated in FIG. 7.

Note that when scheduling multiple UEs with multi-PDSCH or multi-PUSCH transmission using a single DCI, a common Radio Network Temporary Identifier (RNTI) may be configured or indicated by higher layers via remaining minimum system information (RMSI), other system information (OSI) or dedicated radio resource control (RRC) signalling.

Scheduling of multiple UEs with the same DCI, as illustrated in FIG. 7, may be especially useful when some of the DCI parameters are shared between the scheduled UEs. For example, the UEs scheduled in the downlink may be served with the same Tx beam. In this case, the same single TCI state from the DCI could be used by the scheduled UEs. However, in some embodiments, Tx beam indication may differ for the UEs scheduled with the same DCI. In this case, different beam indication per scheduled UE is also included into the scheduling DCI.

### Time Domain Resource Allocation for Data Channel

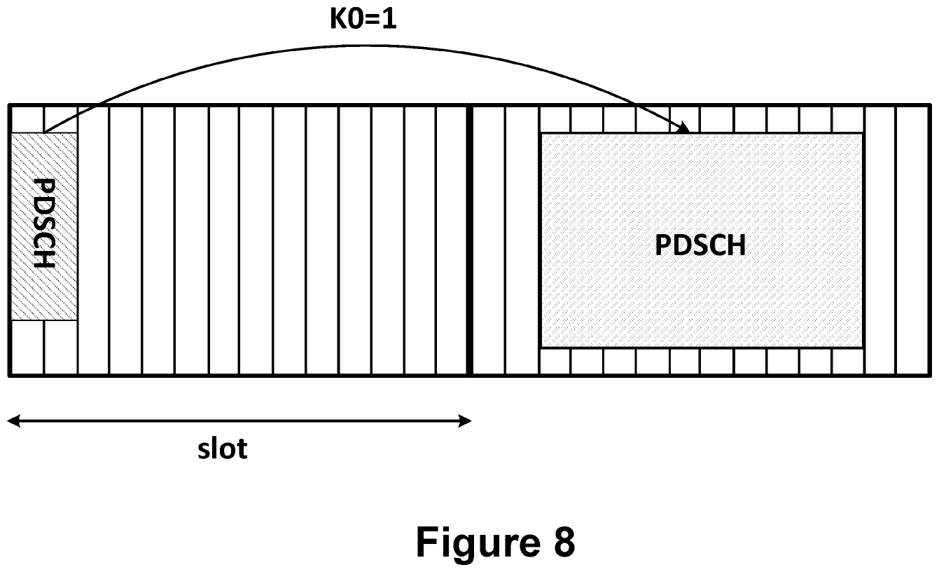

In NR Rel-15, starting and length indicator value (SLIV) is used to indicate the time domain resource allocation (TDRA) within a slot for data transmission. Further, a list of time domain resource allocations can be configured by higher layers, which includes k0 or k2, mapping type and SLIV in a slot. In particular, k0 and k2 are the slot offset between downlink control information (DCI) and its scheduled physical downlink shared channel (PDSCH) and physical uplink shared channel (PUSCH), respectively. FIG. 8 illustrates one example of single PDSCH scheduling. In the figure, k0=1 and starting symbol and length of PDSCH is symbol #2 and 10 symbols, respectively.

Further, in Rel-16, number of repetitions can be configured as part of TDRA for the PDSCH and PUSCH transmission. When one TDRA with number of repetitions from a list of TDRA is selected and indicated in the downlink control information (DCI), the number of repetitions can be applied for the transmission of PDSCH and PUSCH.

For system operating above 52.6 GHz carrier frequency, when a large subcarrier spacing, e.g., 480 kHz or 960 kHz is used, symbol and slot duration is very short, which may pose certain constraint for scheduler implementation. To alleviate scheduler constraint and relax higher layer processing burden, multi-transmit time interval (TTI) based scheduling can be employed, where one physical downlink control channel (PDCCH) can be used to schedule multiple PDSCHs or PUSCH carrying independent TBs. Based on this mechanism, scheduler implementation and higher layer processing burdened can be relaxed, while maintaining same peak data rate.

To further improve the coverage for uplink transmission, single transport block (TB) may span more than one slots. This can be applied in conjunction with multi-PDSCH or multi-PUSCH scheduling. Similar mechanism can also be applied when repetition is used for PDSCH and PUSCH transmission. Considering all different scheduling mechanisms for data transmission, including single slot transmission, multi-slot transmission, TB spanning multiple slots, repetitions, etc., time domain resource allocation needs to be enhanced for PDSCH and PUSCH transmission.

Embodiments herein provide unified mechanisms for time domain resource allocation for data transmission.

### A unified Mechanism for Time Domain Resource Allocation for Data Transmission

As mentioned above, for system operating above 52.6 GHz carrier frequency, when a large subcarrier spacing, e.g., 480 kHz or 960 kHz is used, symbol and slot duration is very short, which may pose certain constraint for scheduler implementation. To alleviate scheduler constraint and relax higher layer processing burden, multi-transmit time interval (TTI) based scheduling can be employed, where one physical downlink control channel (PDCCH) can be used to schedule multiple PDSCHs or PUSCH carrying independent TBs. Based on this mechanism, scheduler implementation and higher layer processing burdened can be relaxed, while maintaining same peak data rate.

To further improve the coverage for uplink transmission, single transport block (TB) may span more than one slots. This can be applied in conjunction with multi-PDSCH or multi-PUSCH scheduling. Similar mechanism can also be applied when repetition is used for PDSCH and PUSCH transmission. Considering all different scheduling mechanisms for data transmission, including single slot transmission, multi-slot transmission, TB spanning multiple slots, repetitions, etc., time domain resource allocation needs to be enhanced for PDSCH and PUSCH transmission.

Embodiments of a unified mechanism for time domain resource allocation for data transmission are provided as follows:

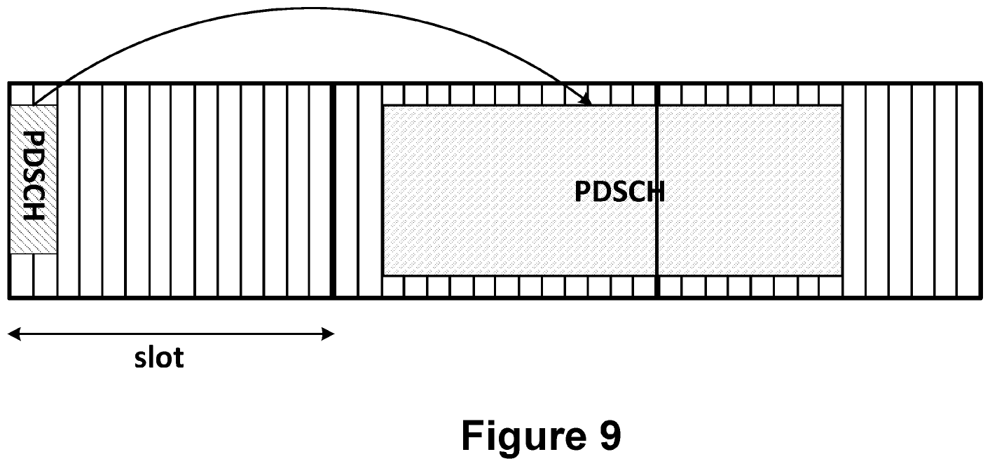

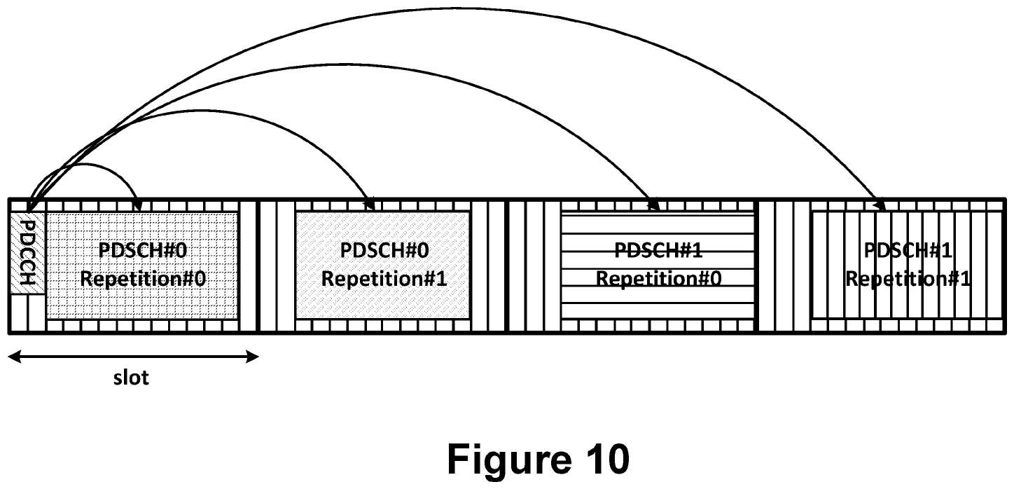

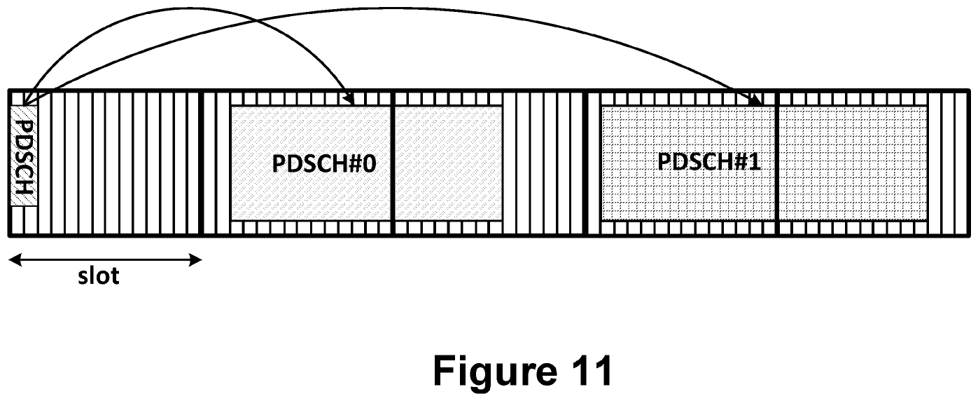

In one embodiment, one TDRA table may be used to schedule one or more following types of data transmission:
Single PDSCH or PUSCH, where each PDSCH or PUSCH is scheduled within a slot
Single PDSCH or PUSCH with repetition, where each PDSCH or PUSCH is scheduled with more than one repetition.
Single PDSCH or PUSCH, where each PDSCH or PUSCH spans more than one slot, as shown in FIG. 9.
Multi-PDSCH or multi-PUSCH transmission, where each PDSCH or PUSCH is located within a slot, as shown in FIG. 1 introduced previously.
Multi-PDSCH or multi-PUSCH transmission, where each PDSCH or PUSCH is scheduled with more than one repetition and each repetition is located within a slot, as shown in FIG. 10.
Multi-PDSCH or multi-PUSCH transmission, where each PDSCH or PUSCH carrying a TB spans more than one slot, as shown in FIG. 11. Note that although consecutive symbols are allocated for PDSCH with a TB spanning multiple slots, the design can be straightforwardly extended to the case when same TDRA is applied for different slots for scheduled PDSCHs.

Note that for the above types of data transmission, each PDSCH or PUSCH may carry one or more TB or more than one code block groups (CBG).

Further, when repetition is employed for the transmission of PDSCH or PUSCH, repetition type A or type B may be employed for the PDSCH or PUSCH repetition. For repetition type A, each repetition is located within a slot; while for repetition type B, consecutive SLIV is allocated for TDRA for PDSCH or PUSCH repetition.

Note that the following embodiments may not be limited to repetition type A or type B. For instance, different SLIVs may be allocated for different repetitions in different slots and different repetitions may be non-consecutive in time.

Further, if a UE is configured to support a subset or all type of the aforementioned type of data transmission, a subset of TDRA lists can be configured for one type of data transmissions. When UE is scheduled with an entry of the configured TDRA list, UE can derive the type of data transmission for PDSCH and PUSCH.

Table 1 illustrates one example of TDRA list partition to indicate the type of data transmission. In the example, if all different types of data transmissions are configured for a UE, TDRA list partition to indicate the type of data transmission. In particular, the number of entries for different types of data transmission can be predefined in the specification or configured by higher layers via MSI, RMSI (SIB1), OSI or RRC signalling.

In the example, N0, N1, N2 N3 can be configured by higher layers via MSI, RMSI (SIB1), OSI or RRC signalling. Further, entries from 0 to N0−1 are for TDRA list for single PDSCH or PUSCH with or without repetition; entries from N0 to N1−1 are for TDRA list for single PDSCH or PUSCH with a TB spanning more than one slot; entries from N1 to N2−1 are for TDRA list for multi-PDSCH or multi-PUSCH transmission with or without repetition for each scheduled PDSCH or PUSCH; entries from N2 to N3−1 are for TDRA list for multi-PDSCH or multi-PUSCH transmission, where each PDSCH or PUSCH carrying a TB spans more than one slot.

TABLE 1
TDRA list partition to indicate the type of data transmission

| Entry index | TDRA list |
|---|---|
| Entry 0 | TDRA list for single PDSCH or PUSCH with or without |
| . . . | repetition |
| Entry N₀ − 1 | |
| Entry N₀ | TDRA list for single PDSCH or PUSCH with a TB |
| . . . | spanning more than one slot |
| Entry N₁ − 1 | |
| Entry N₁ | TDRA list for multi-PDSCH or multi-PUSCH transmission |
| . . . | with or without repetition for each scheduled PDSCH or |
| Entry N₂ − 1 | PUSCH |
| Entry N₂ | TDRA list for multi-PDSCH or multi-PUSCH transmission, |
| . . . | where each PDSCH or PUSCH carrying a TB spans more |
| Entry N₃ − 1 | than one slot |

In another embodiment, indication of one or more of the above type of data transmissions can be configured by higher layers via minimum system information (MSI), remaining minimum system information (RMSI), other system information (OSI) or dedicated radio resource control (RRC) signalling or indicated in the DCI or a combination thereof.

In one example, 2-bit identifier for type of data transmission can be explicitly indicated in the DCI, as shown in Table 2. Note that the identifier may also be indicated as a part of TDRA.

TABLE 2
Identifier for type of data transmission: Example 1

| Identifier for type | |
|---|---|
| of data transmission | Type of data transmission |
| 00 | Single PDSCH or PUSCH with repetition |
| 01 | Single PDSCH or PUSCH with a TB spanning more |
| | than one slot |
| 10 | Multi-PDSCH or multi-PUSCH transmission with |
| | repetition for each scheduled PDSCH or PUSCH |
| 11 | Multi-PDSCH or multi-PUSCH transmission, where |
| | each PDSCH or PUSCH carrying a TB spans more |
| | than one slot |

In another example, 1-bit identifier for type of data transmission can be explicitly indicated in the DCI, as shown in Table 2. In this case, the number of scheduled PDSCHs or PUSCHs can be implicitly derived in accordance with the number of TDRA or SLIVs for the scheduled entry of TDRA list.

TABLE 3
Identifier for type of data transmission: Example 2

| Identifier for type | |
|---|---|
| of data transmission | Type of data transmission |
| 0 | PDSCH or PUSCH with repetition |
| 1 | PDSCH or PUSCH with a TB spanning more than |
| | one slot |

In another embodiment, for each entry of TDRA list, one or more parameters for TDRA can be commonly applied for all the scheduled PDSCHs or PUSCHs, while the remaining parameters for TDRA can be independently configured for different scheduled PDSCHs or PUSCHs.

The parameters for TDRA may include k0 or k2; mapping type; SLIV for each scheduled PDSCH or PUSCH in a slot; number of repetitions for each scheduled PDSCH or PUSCH if repetition is applied for the transmission of PDSCH or PUSCH; number of slots for each scheduled PDSCH or PUSCH if each PDSCH or PUSCH carrying a TB spans more than one slot.

In one example, if only one PDSCH or PUSCH is scheduled with repetition, a single k0 or k2 and number of repetitions, and same mapping type can be applied for the scheduled PDSCH or PUSCH, respectively. Note that the k0 or k2 can be applied for the first repetition of scheduled PDSCH or PUSCH, respectively. Further, a list of SLIVs can be applied for scheduled PDSCH repetition or PUSCH repetition.

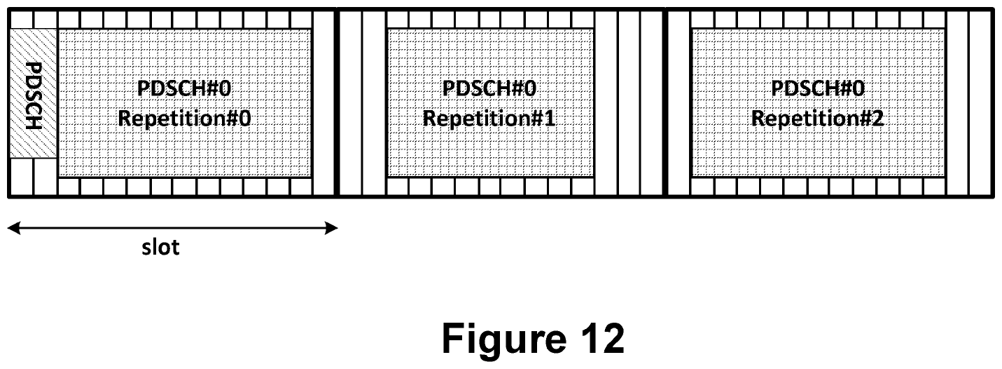

FIG. 12 illustrates one example of different SLIVs for scheduled PDSCH with repetition. In this example, different SLIVs are applied for different PDSCH repetitions.

In one example, if repetition is applied for the transmission of more than one PDSCHs or PUSCHs, a single k0 or k2, same mapping type and number of repetitions can be applied for all the scheduled PDSCHs or PUSCHs, respectively. Note that the k0 or k2 can be applied for the first repetition of first scheduled PDSCH or PUSCH, respectively. In addition, the repetition for the first PDSCH or PUSCH and subsequent PDSCH or PUSCH is scheduled in the adjacent slot after the first repetition of the first PDSCH. Alternatively, subsequent PDSCH or PUSCH repetition may follow right after the first PDSCH or PUSCH repetition, respectively. In this case, consecutive SLIV may be allocated for PDSCH or PUSCH repetition.

Further, a list of SLIVs can be applied for scheduled PDSCHs or PUSCHs, where a first SLIV is allocated for the first PDSCH or PUSCH with repetitions, a second SLIV is allocated for the second PDSCH or PUSCH with repetitions, and so on. For example, the list of SLIVs can occupy consecutive symbols.

In another example, if repetition is applied for the transmission of PDSCHs or PUSCHs, a single k0 or k2, and a same/common mapping type can be applied for scheduled PDSCHs or PUSCH, respectively. Further, a list of {SLIV, number of repetitions} can be applied for scheduled PDSCHs or PUSCHs, where a first {SLIV, number of repetitions} is applied for the first PDSCH or PUSCH, a second {SLIV, number of repetitions} is applied for the second PDSCH or PUSCH, and so on. Note that in this example, different SLIVs and number of repetitions can be applied for different scheduled PDSCHs or PUSCHs. Alternatively, repetition type A or type B may be applied for the transmission of PDSCHs or PUSCHs with repetition.

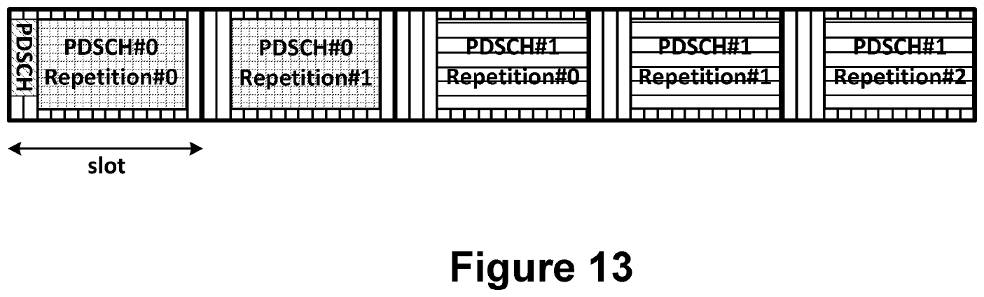

FIG. 13 illustrates one example of different SLIVs and number of repetitions for scheduled PDSCHs. In the example, starting symbol and length for PDSCH #0 is symbol #2 and 11 symbols, and number of repetitions for PDSCH #0 is 2. In addition, starting symbol and length for PDSCH #1 is symbol #3 and 11 symbols, and number of repetitions for PDSCH #0 is 3. Further, same SLIV is applied for the repetition for each scheduled PDSCH.

In another example, if each PDSCH or PUSCH carrying a TB spans more than one slot, a single k0 or k2 and same mapping type can be applied for scheduled PDSCHs or PUSCH, respectively. Further, a list of {SLIV, number of slots} can be applied for scheduled PDSCHs or PUSCHs, where a first {SLIV, number of slots} is applied for the first PDSCH or PUSCH, a second {SLIV, number of slots} is applied for the second PDSCH or PUSCH, and so on.

Note that for this example, it is assumed that same SLIV is applied for a PDSCH or PUSCH with a TB spanning more than one slot. Similar mechanism can be also applied for the case when consecutive number of symbols in multiple slots is applied for the PDSCH or PUSCH with a TB spanning more than one slot. In this case, only SLIV may be used for PDSCH or PUSCH resource allocation in time, where length of PDSCH or PUSCH may be larger than 14 symbols.

In another embodiment, for each entry of TDRA list, all parameters for TDRA can be independently configured for different scheduled PDSCHs or PUSCHs. In this case, number of scheduled PDSCHs can be derived in accordance with number of TDRA in the entry of TDRA list.

In one example, for each entry of TDRA list, if repetition is applied for each scheduled PDSCH, a list of {k0, mapping type, SLIV, number of repetitions} can be applied for scheduled PDSCHs, where a first {k0, mapping type, SLIV, number of repetitions} is applied for the first scheduled PDSCH, a second {k0, mapping type, SLIV, number of repetitions} is applied for the second scheduled PDSCH, and so on. In another example, if repetition is not applied for each scheduled PDSCH, a list of {k0, mapping type, SLIV} can be applied for scheduled PDSCHs, where a first {k0, mapping type, SLIV} is applied for the first scheduled PDSCH, a second {k0, mapping type, SLIV} is applied for the second scheduled PDSCH, and so on.

### SYSTEMS AND IMPLEMENTATIONS

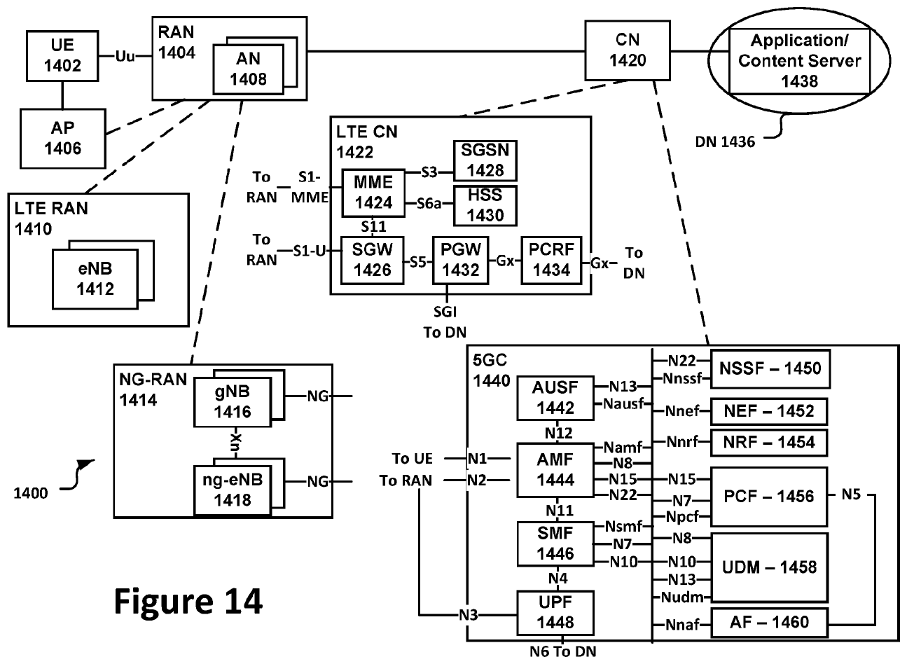

FIGS. 14-16 illustrate various systems, devices, and components that may implement aspects of disclosed embodiments.

FIG. 14 illustrates a network 1400 in accordance with various embodiments. The network 1400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1400 may include a UE 1402, which may include any mobile or non-mobile computing device designed to communicate with a RAN 1404 via an over-the-air connection. The UE 1402 may be communicatively coupled with the RAN 1404 by a Uu interface. The UE 1402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1402 may additionally communicate with an AP 1406 via an over-the-air connection. The AP 1406 may manage a WLAN connection, which may serve to offload some/all network traffic from the RAN 1404. The connection between the UE 1402 and the AP 1406 may be consistent with any IEEE 802.11 protocol, wherein the AP 1406 could be a wireless fidelity (Wi-Fi®) router. In some embodiments, the UE 1402, RAN 1404, and AP 1406 may utilize cellular-WLAN aggregation (for example, LWA/LWIP). Cellular-WLAN aggregation may involve the UE 1402 being configured by the RAN 1404 to utilize both cellular radio resources and WLAN resources.

The RAN 1404 may include one or more access nodes, for example, AN 1408. AN 1408 may terminate air-interface protocols for the UE 1402 by providing access stratum protocols including RRC, PDCP, RLC, MAC, and L1 protocols. In this manner, the AN 1408 may enable data/voice connectivity between CN 1420 and the UE 1402. In some embodiments, the AN 1408 may be implemented in a discrete device or as one or more software entities running on server computers as part of, for example, a virtual network, which may be referred to as a CRAN or virtual baseband unit pool. The AN 1408 be referred to as a BS, gNB, RAN node, eNB, ng-eNB, NodeB, RSU, TRxP, TRP, etc. The AN 1408 may be a macrocell base station or a low power base station for providing femtocells, picocells or other like cells having smaller coverage areas, smaller user capacity, or higher bandwidth compared to macrocells.

In embodiments in which the RAN 1404 includes a plurality of ANs, they may be coupled with one another via an X2 interface (if the RAN 1404 is an LTE RAN) or an Xn interface (if the RAN 1404 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1404 may each manage one or more cells, cell groups, component carriers, etc. to provide the UE 1402 with an air interface for network access. The UE 1402 may be simultaneously connected with a plurality of cells provided by the same or different ANs of the RAN 1404. For example, the UE 1402 and RAN 1404 may use carrier aggregation to allow the UE 1402 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1402 or AN 1408 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1404 may be an LTE RAN 1410 with eNBs, for example, eNB 1412. The LTE RAN 1410 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1404 may be an NG-RAN 1414 with gNBs, for example, gNB 1416, or ng-eNBs, for example, ng-eNB 1418. The gNB 1416 may connect with 5G-enabled UEs using a 5G NR interface. The gNB 1416 may connect with a 5G core through an NG interface, which may include an N2 interface or an N3 interface. The ng-eNB 1418 may also connect with the 5G core through an NG interface, but may connect with a UE via an LTE air interface. The gNB 1416 and the ng-eNB 1418 may connect with each other over an Xn interface.

In some embodiments, the NG interface may be split into two parts, an NG user plane (NG-U) interface, which carries traffic data between the nodes of the NG-RAN 1414 and a UPF 1448 (e.g., N3 interface), and an NG control plane (NG-C) interface, which is a signaling interface between the nodes of the NG-RAN 1414 and an AMF 1444 (e.g., N2 interface).

The NG-RAN 1414 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1402 can be configured with multiple BWPs where each BWP configuration has a different SCS. When a BWP change is indicated to the UE 1402, the SCS of the transmission is changed as well. Another use case example of BWP is related to power saving. In particular, multiple BWPs can be configured for the UE 1402 with different amount of frequency resources (for example, PRBs) to support data transmission under different traffic loading scenarios. A BWP containing a smaller number of PRBs can be used for data transmission with small traffic load while allowing power saving at the UE 1402 and in some cases at the gNB 1416. A BWP containing a larger number of PRBs can be used for scenarios with higher traffic load.

The RAN 1404 is communicatively coupled to CN 1420 that includes network elements to provide various functions to support data and telecommunications services to customers/subscribers (for example, users of UE 1402). The components of the CN 1420 may be implemented in one physical node or separate physical nodes. In some embodiments, NFV may be utilized to virtualize any or all of the functions provided by the network elements of the CN 1420 onto physical compute/storage resources in servers, switches, etc. A logical instantiation of the CN 1420 may be referred to as a network slice, and a logical instantiation of a portion of the CN 1420 may be referred to as a network sub-slice.

In some embodiments, the CN 1420 may be an LTE CN 1422, which may also be referred to as an EPC. The LTE CN 1422 may include MME 1424, SGW 1426, SGSN 1428, HSS 1430, PGW 1432, and PCRF 1434 coupled with one another over interfaces (or “reference points”) as shown. Functions of the elements of the LTE CN 1422 may be briefly introduced as follows.

The MME 1424 may implement mobility management functions to track a current location of the UE 1402 to facilitate paging, bearer activation/deactivation, handovers, gateway selection, authentication, etc.

The SGW 1426 may terminate an S1 interface toward the RAN and route data packets between the RAN and the LTE CN 1422. The SGW 1426 may be a local mobility anchor point for inter-RAN node handovers and also may provide an anchor for inter-3GPP mobility. Other responsibilities may include lawful intercept, charging, and some policy enforcement.

The SGSN 1428 may track a location of the UE 1402 and perform security functions and access control. In addition, the SGSN 1428 may perform inter-EPC node signaling for mobility between different RAT networks; PDN and S-GW selection as specified by MME 1424; MME selection for handovers; etc. The S3 reference point between the MME 1424 and the SGSN 1428 may enable user and bearer information exchange for inter-3GPP access network mobility in idle/active states.

The HSS 1430 may include a database for network users, including subscription-related information to support the network entities' handling of communication sessions. The HSS 1430 can provide support for routing/roaming, authentication, authorization, naming/addressing resolution, location dependencies, etc. An S6a reference point between the HSS 1430 and the MME 1424 may enable transfer of subscription and authentication data for authenticating/authorizing user access to the LTE CN 1420.

The PGW 1432 may terminate an SGi interface toward a data network (DN) 1436 that may include an application/content server 1438. The PGW 1432 may route data packets between the LTE CN 1422 and the data network 1436. The PGW 1432 may be coupled with the SGW 1426 by an S5 reference point to facilitate user plane tunneling and tunnel management. The PGW 1432 may further include a node for policy enforcement and charging data collection (for example, PCEF). Additionally, the SGi reference point between the PGW 1432 and the data network 1436 may be an operator external public, a private PDN, or an intra-operator packet data network, for example, for provision of IMS services. The PGW 1432 may be coupled with a PCRF 1434 via a Gx reference point.

The PCRF 1434 is the policy and charging control element of the LTE CN 1422. The PCRF 1434 may be communicatively coupled to the app/content server 1438 to determine appropriate QoS and charging parameters for service flows. The PCRF 1432 may provision associated rules into a PCEF (via Gx reference point) with appropriate TFT and QCI.

In some embodiments, the CN 1420 may be a 5GC 1440. The 5GC 1440 may include an AUSF 1442, AMF 1444, SMF 1446, UPF 1448, NSSF 1450, NEF 1452, NRF 1454, PCF 1456, UDM 1458, and AF 1460 coupled with one another over interfaces (or “reference points”) as shown. Functions of the elements of the 5GC 1440 may be briefly introduced as follows.

The AUSF 1442 may store data for authentication of UE 1402 and handle authentication-related functionality. The AUSF 1442 may facilitate a common authentication framework for various access types. In addition to communicating with other elements of the 5GC 1440 over reference points as shown, the AUSF 1442 may exhibit an Nausf service-based interface.

The AMF 1444 may allow other functions of the 5GC 1440 to communicate with the UE 1402 and the RAN 1404 and to subscribe to notifications about mobility events with respect to the UE 1402. The AMF 1444 may be responsible for registration management (for example, for registering UE 1402), connection management, reachability management, mobility management, lawful interception of AMF-related events, and access authentication and authorization. The AMF 1444 may provide transport for SM messages between the UE 1402 and the SMF 1446, and act as a transparent proxy for routing SM messages. AMF 1444 may also provide transport for SMS messages between UE 1402 and an SMSF. AMF 1444 may interact with the AUSF 1442 and the UE 1402 to perform various security anchor and context management functions. Furthermore, AMF 1444 may be a termination point of a RAN CP interface, which may include or be an N2 reference point between the RAN 1404 and the AMF 1444; and the AMF 1444 may be a termination point of NAS (N1) signaling, and perform NAS ciphering and integrity protection. AMF 1444 may also support NAS signaling with the UE 1402 over an N3 IWF interface.

The SMF 1446 may be responsible for SM (for example, session establishment, tunnel management between UPF 1448 and AN 1408); UE IP address allocation and management (including optional authorization); selection and control of UP function; configuring traffic steering at UPF 1448 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1444 over N2 to AN 1408; and determining SSC mode of a session. SM may refer to management of a PDU session, and a PDU session or “session” may refer to a PDU connectivity service that provides or enables the exchange of PDUs between the UE 1402 and the data network 1436.

The UPF 1448 may act as an anchor point for intra-RAT and inter-RAT mobility, an external PDU session point of interconnect to data network 1436, and a branching point to support multi-homed PDU session. The UPF 1448 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1448 may include an uplink classifier to support routing traffic flows to a data network.

The NSSF 1450 may select a set of network slice instances serving the UE 1402. The NSSF 1450 may also determine allowed NSSAI and the mapping to the subscribed S-NSSAIs, if needed. The NSSF 1450 may also determine the AMF set to be used to serve the UE 1402, or a list of candidate AMFs based on a suitable configuration and possibly by querying the NRF 1454. The selection of a set of network slice instances for the UE 1402 may be triggered by the AMF 1444 with which the UE 1402 is registered by interacting with the NSSF 1450, which may lead to a change of AMF. The NSSF 1450 may interact with the AMF 1444 via an N22 reference point; and may communicate with another NSSF in a visited network via an N31 reference point (not shown). Additionally, the NSSF 1450 may exhibit an Nnssf service-based interface.

The NEF 1452 may securely expose services and capabilities provided by 3GPP network functions for third party, internal exposure/re-exposure, AFs (e.g., AF 1460), edge computing or fog computing systems, etc. In such embodiments, the NEF 1452 may authenticate, authorize, or throttle the AFs. NEF 1452 may also translate information exchanged with the AF 1460 and information exchanged with internal network functions. For example, the NEF 1452 may translate between an AF-Service-Identifier and an internal 5GC information. NEF 1452 may also receive information from other NFs based on exposed capabilities of other NFs. This information may be stored at the NEF 1452 as structured data, or at a data storage NF using standardized interfaces. The stored information can then be re-exposed by the NEF 1452 to other NFs and AFs, or used for other purposes such as analytics. Additionally, the NEF 1452 may exhibit an Nnef service-based interface.

The NRF 1454 may support service discovery functions, receive NF discovery requests from NF instances, and provide the information of the discovered NF instances to the NF instances. NRF 1454 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1454 may exhibit the Nnrf service-based interface.

The PCF 1456 may provide policy rules to control plane functions to enforce them, and may also support unified policy framework to govern network behavior. The PCF 1456 may also implement a front end to access subscription information relevant for policy decisions in a UDR of the UDM 1458. In addition to communicating with functions over reference points as shown, the PCF 1456 exhibit an Npcf service-based interface.

The UDM 1458 may handle subscription-related information to support the network entities' handling of communication sessions, and may store subscription data of UE 1402. For example, subscription data may be communicated via an N8 reference point between the UDM 1458 and the AMF 1444. The UDM 1458 may include two parts, an application front end and a UDR. The UDR may store subscription data and policy data for the UDM 1458 and the PCF 1456, and/or structured data for exposure and application data (including PFDs for application detection, application request information for multiple UEs 1402) for the NEF 1452. The Nudr service-based interface may be exhibited by the UDR 221 to allow the UDM 1458, PCF 1456, and NEF 1452 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1458 may exhibit the Nudm service-based interface.

The AF 1460 may provide application influence on traffic routing, provide access to NEF, and interact with the policy framework for policy control.

In some embodiments, the 5GC 1440 may enable edge computing by selecting operator/3^{rd} party services to be geographically close to a point that the UE 1402 is attached to the network. This may reduce latency and load on the network. To provide edge-computing implementations, the 5GC 1440 may select a UPF 1448 close to the UE 1402 and execute traffic steering from the UPF 1448 to data network 1436 via the N6 interface. This may be based on the UE subscription data, UE location, and information provided by the AF 1460. In this way, the AF 1460 may influence UPF (re)selection and traffic routing. Based on operator deployment, when AF 1460 is considered to be a trusted entity, the network operator may permit AF 1460 to interact directly with relevant NFs. Additionally, the AF 1460 may exhibit an Naf service-based interface.

The data network 1436 may represent various network operator services, Internet access, or third party services that may be provided by one or more servers including, for example, application/content server 1438.

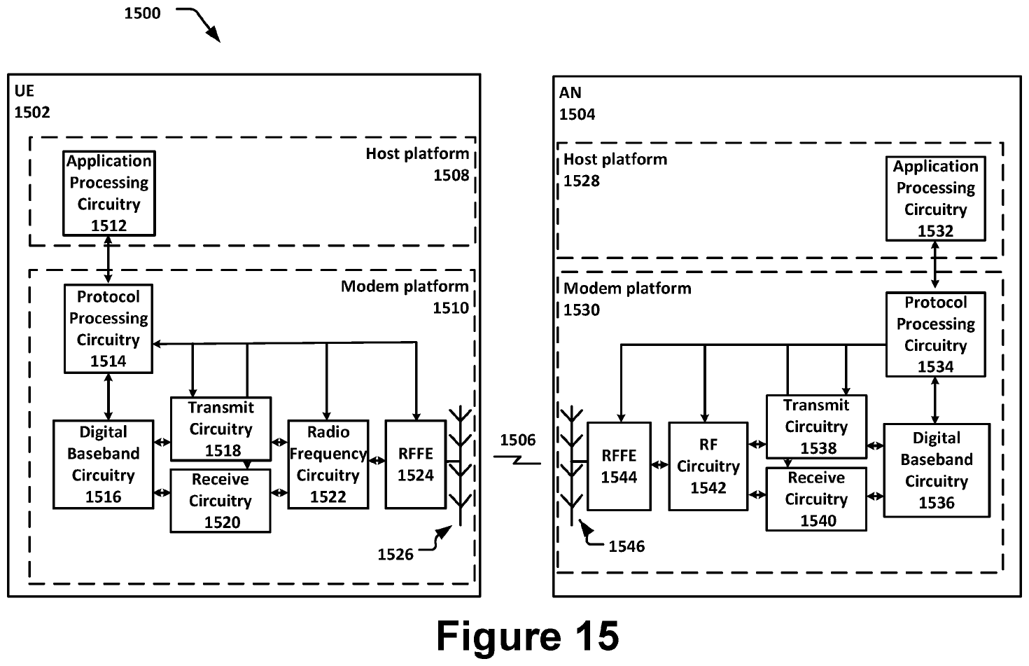

FIG. 15 schematically illustrates a wireless network 1500 in accordance with various embodiments. The wireless network 1500 may include a UE 1502 in wireless communication with an AN 1504. The UE 1502 and AN 1504 may be similar to, and substantially interchangeable with, like-named components described elsewhere herein.

The UE 1502 may be communicatively coupled with the AN 1504 via connection 1506. The connection 1506 is illustrated as an air interface to enable communicative coupling, and can be consistent with cellular communications protocols such as an LTE protocol or a 5G NR protocol operating at mmWave or sub-6GHz frequencies.

The UE 1502 may include a host platform 1508 coupled with a modem platform 1510. The host platform 1508 may include application processing circuitry 1512, which may be coupled with protocol processing circuitry 1514 of the modem platform 1510. The application processing circuitry 1512 may run various applications for the UE 1502 that source/sink application data. The application processing circuitry 1512 may further implement one or more layer operations to transmit/receive application data to/from a data network. These layer operations may include transport (for example UDP) and Internet (for example, IP) operations

The protocol processing circuitry 1514 may implement one or more of layer operations to facilitate transmission or reception of data over the connection 1506. The layer operations implemented by the protocol processing circuitry 1514 may include, for example, MAC, RLC, PDCP, RRC and NAS operations.

The modem platform 1510 may further include digital baseband circuitry 1516 that may implement one or more layer operations that are “below” layer operations performed by the protocol processing circuitry 1514 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1510 may further include transmit circuitry 1518, receive circuitry 1520, RF circuitry 1522, and RF front end (RFFE) 1524, which may include or connect to one or more antenna panels 1526. Briefly, the transmit circuitry 1518 may include a digital-to-analog converter, mixer, intermediate frequency (IF) components, etc.; the receive circuitry 1520 may include an analog-to-digital converter, mixer, IF components, etc.; the RF circuitry 1522 may include a low-noise amplifier, a power amplifier, power tracking components, etc.; RFFE 1524 may include filters (for example, surface/bulk acoustic wave filters), switches, antenna tuners, beamforming components (for example, phase-array antenna components), etc. The selection and arrangement of the components of the transmit circuitry 1518, receive circuitry 1520, RF circuitry 1522, RFFE 1524, and antenna panels 1526 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1514 may include one or more instances of control circuitry (not shown) to provide control functions for the transmit/receive components.

A UE reception may be established by and via the antenna panels 1526, RFFE 1524, RF circuitry 1522, receive circuitry 1520, digital baseband circuitry 1516, and protocol processing circuitry 1514. In some embodiments, the antenna panels 1526 may receive a transmission from the AN 1504 by receive-beamforming signals received by a plurality of antennas/antenna elements of the one or more antenna panels 1526.

A UE transmission may be established by and via the protocol processing circuitry 1514, digital baseband circuitry 1516, transmit circuitry 1518, RF circuitry 1522, RFFE 1524, and antenna panels 1526. In some embodiments, the transmit components of the UE 1504 may apply a spatial filter to the data to be transmitted to form a transmit beam emitted by the antenna elements of the antenna panels 1526.

Similar to the UE 1502, the AN 1504 may include a host platform 1528 coupled with a modem platform 1530. The host platform 1528 may include application processing circuitry 1532 coupled with protocol processing circuitry 1534 of the modem platform 1530. The modem platform may further include digital baseband circuitry 1536, transmit circuitry 1538, receive circuitry 1540, RF circuitry 1542, RFFE circuitry 1544, and antenna panels 1546. The components of the AN 1504 may be similar to and substantially interchangeable with like-named components of the UE 1502. In addition to performing data transmission/reception as described above, the components of the AN 1508 may perform various logical functions that include, for example, RNC functions such as radio bearer management, uplink and downlink dynamic radio resource management, and data packet scheduling.

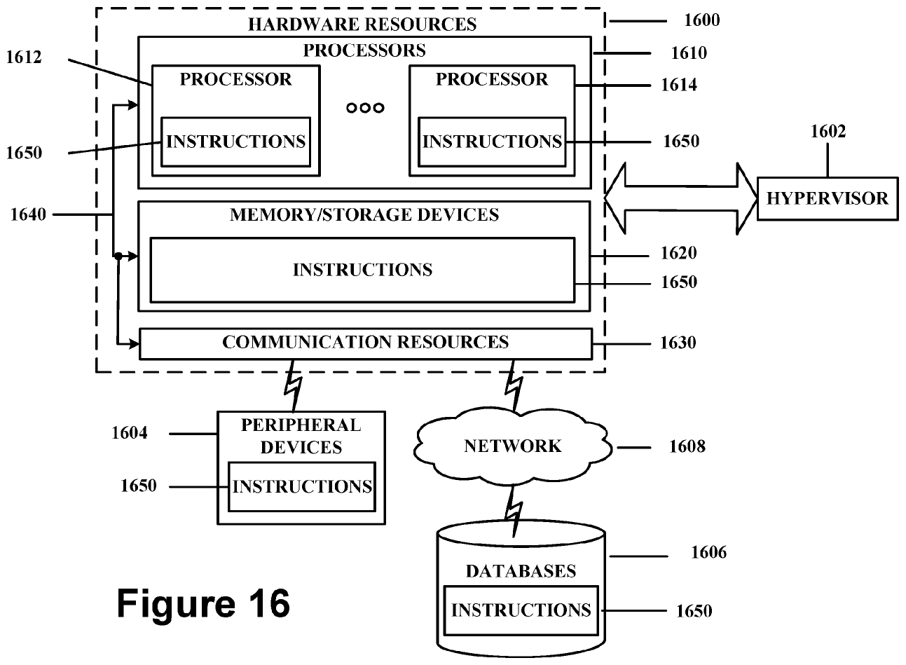

FIG. 16 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 16 shows a diagrammatic representation of hardware resources 1600 including one or more processors (or processor cores) 1610, one or more memory/storage devices 1620, and one or more communication resources 1630, each of which may be communicatively coupled via a bus 1640 or other interface circuitry. For embodiments where node virtualization (e.g., NFV) is utilized, a hypervisor 1602 may be executed to provide an execution environment for one or more network slices/sub-slices to utilize the hardware resources 1600.

The processors 1610 may include, for example, a processor 1612 and a processor 1614. The processors 1610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1620 may include main memory, disk storage, or any suitable combination thereof. The memory/storage devices 1620 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1630 may include interconnection or network interface controllers, components, or other suitable devices to communicate with one or more peripheral devices 1604 or one or more databases 1606 or other network elements via a network 1608. For example, the communication resources 1630 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1650 may comprise software, a program, an application, an applet, an app, or other executable code for causing at least any of the processors 1610 to perform any one or more of the methodologies discussed herein. The instructions 1650 may reside, completely or partially, within at least one of the processors 1610 (e.g., within the processor's cache memory), the memory/storage devices 1620, or any suitable combination thereof. Furthermore, any portion of the instructions 1650 may be transferred to the hardware resources 1600 from any combination of the peripheral devices 1604 or the databases 1606. Accordingly, the memory of processors 1610, the memory/storage devices 1620, the peripheral devices 1604, and the databases 1606 are examples of computer-readable and machine-readable media.

### EXAMPLE PROCEDURES

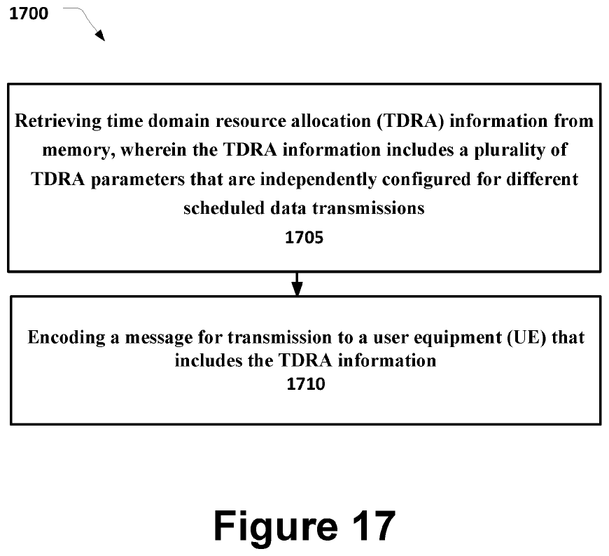

In some embodiments, the electronic device(s), network(s), system(s), chip(s) or component(s), or portions or implementations thereof, of FIGS. 14-16, or some other figure herein, may be configured to perform one or more processes, techniques, or methods as described herein, or portions thereof. One such process is depicted in FIG. 17. For example, process 1700 may include, at 1705, retrieving time domain resource allocation (TDRA) information from memory, wherein the TDRA information includes a plurality of TDRA parameters that are independently configured for different scheduled data transmissions. The process further includes, at 1710, encoding a message for transmission to a user equipment (UE) that includes the TDRA information.

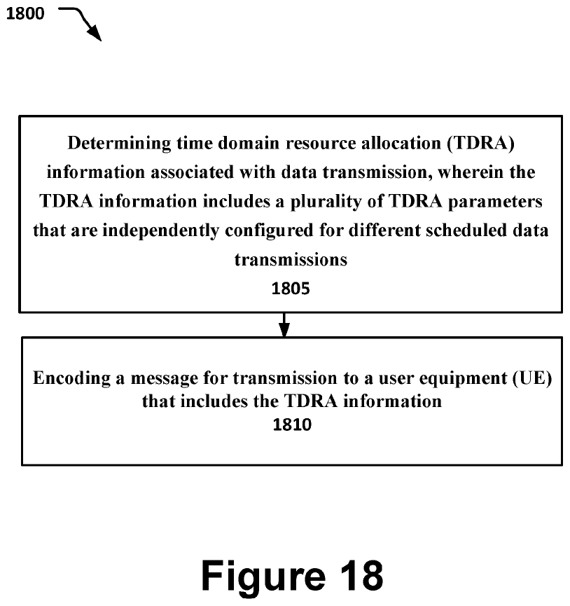

Another such process is illustrated in FIG. 18. In this example, the process 1800 includes, at 1805, determining time domain resource allocation (TDRA) information associated with data transmission, wherein the TDRA information includes a plurality of TDRA parameters that are independently configured for different scheduled data transmissions. The process further includes, at 1810, encoding a message for transmission to a user equipment (UE) that includes the TDRA information.

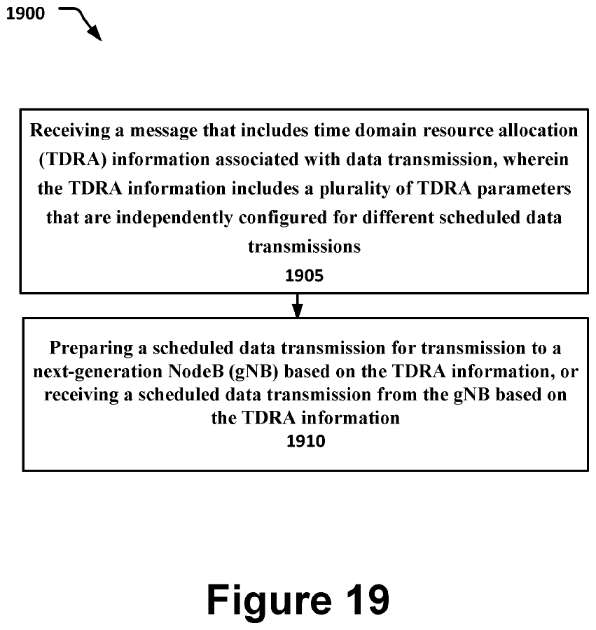

Another such process is illustrated in FIG. 19. In this example, the process 1900 includes, at 1905, receiving a message that includes time domain resource allocation (TDRA) information associated with data transmission, wherein the TDRA information includes a plurality of TDRA parameters that are independently configured for different scheduled data transmissions. The process further includes, at 1910, preparing a scheduled data transmission for transmission to a next-generation NodeB (gNB) based on the TDRA information, or receiving a scheduled data transmission from the gNB based on the TDRA information.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method of wireless communication for a fifth generation (5G) or new radio (NR) system, comprising:
decoding, by a UE, a single downlink control information (DCI) for scheduling more than one physical uplink shared channels (PUSCH) or more than one physical downlink shared channels (PDSCH);
transmitting, by the UE, the multiple PUSCHs using different transmit beams; and
receiving, by the UE, the multiple PDSCHs using different receive beams.

Example 2 may include the method of example 1 or some other example herein, wherein for frequency division multiplexing (FDM) based scheme, same frequency domain resource allocation (FDRA) is allocated for all scheduled PDSCHs for different transmit and receive points (TRP) in case when multi-PDSCH scheduling is applied.

Example 3 may include the method of example 1 or some other example herein, wherein when multi-PDSCH scheduling is applied for TDM scheme A for multi-TRP operation, two repetitions in a slot are applied for all the scheduled PDSCHs, where different TRPs or TCI states are applied for each repetition of a PDSCH.

Example 4 may include the method of example 1 or some other example herein, wherein same number of symbols is applied for the first and second transmission occasions for a PDSCH for multi-PDSCH scheduling; wherein same or different starting symbol offsets may be applied for the last symbol of the first transmission occasions and first symbol of the second transmission occasions.

Example 5 may include the method of example 1 or some other example herein, wherein for multi-PDSCH scheduling, when repetitions are applied for the transmission of scheduled PDSCHs, different beams can be applied for all the scheduled PDSCHs in different transmission occasions.

Example 6 may include the method of example 1 or some other example herein, wherein when two TCI states are indicated by the DCI field ‘Transmission Configuration Indication’ for multi-PDSCH scheduling, a first TCI state is applied for a first transmission occasions of all the scheduled PDSCHs, followed by a second TCI state for a second transmission occasions of all the scheduled PDSCHs.

Example 7 may include the method of example 1 or some other example herein, wherein when two TCI states are indicated by the DCI field ‘Transmission Configuration Indication’ for multi-PDSCH scheduling, a first and second TCI states are applied for repetitions of a first PDSCH, followed by the first and second TCI state for repetitions of a second PDSCH.

Example 8 may include the method of example 1 or some other example herein, wherein for PUSCH repetition type A, when repetitions are applied for the transmission of scheduled PUSCHs in case when multi-PUSCH scheduling is applied, different beams can be applied for all the scheduled PUSCHs in different transmission occasions.

Example 9 may include the method of example 1 or some other example herein, wherein for PUSCH repetition type B, when two sounding reference signal resource indicators (SRI) are indicated or configured in the DCI for multi-PUSCH scheduling, a first and second SRI states are applied for nominal repetitions of a first PUSCH, followed by the first and second SRI state for nominal repetitions of a second PUSCH.

Example 10 may include the method of example 1 or some other example herein, wherein if a PUSCH is repeated two times and respectively transmitted for the two TRPs, aperiodic channel state information (A-CSI) is transmitted on both the two repetitions of the PUSCHs using two beams, respectively.

Example 11 may include the method of example 1 or some other example herein, wherein in case of multi-TRP operation, when PUSCH repetition type A is applied for multi-PUSCH scheduling, A-CSI is transmitted on the first repetition of the penultimate scheduled PUSCH using a first beam while A-CSI is transmitted on the second repetition of the penultimate scheduled PUSCH using a second beam.

Example 12 may include the method of example 1 or some other example herein, wherein in case of multi-TRP operation, when PUSCH repetition type B is applied for multi-PUSCH scheduling, A-CSI is transmitted on the first actual repetition of the penultimate scheduled PUSCH using a first beam, while A-CSI is transmitted on the X-th actual repetition of the penultimate scheduled PUSCH using a second beam, where first actual repetition has same number of symbols as the X actual repetition.

Example 13 may include the method of example 1 or some other example herein, wherein a singe DCI can be used to schedule a group of UEs simultaneously for multiple PDSCHs or PUSCHs.

Example 14 may include the method of example 1 or some other example herein, wherein when scheduling multiple UEs with multi-PDSCH or multi-PUSCH transmission using a single DCI, a common Radio Network Temporary Identifier (RNTI) may be configured or indicated by higher layers via remaining minimum system information (RMSI), other system information (OSI) or dedicated radio resource control (RRC) signalling.

Example 15 includes a method comprising:
determining configuration information for scheduling a plurality of physical downlink shared channel (PDSCH) messages to a user equipment (UE), wherein a frequency domain resource allocation (FDRA) is allocated for all scheduled PDSCHs for different transmit receive points (TRPs) using a frequency division multiplexing (FDM) scheme, or two repetitions per slot are applied for all scheduled PDSCHs for different TRPs using a time division multiplexing (TDM) scheme; and
encoding a downlink control information (DCI) message that includes the configuration information for transmission to the UE.

Example 16 includes the method of example 15 or some other example herein, wherein the configuration information further includes configuration information for scheduling a plurality of physical uplink shared channel (PUSCH) messages, the method further comprising receiving the plurality of PUSCH messages from the UE transmitted using different transmit beams.

Example 17 includes the method of example 15 or some other example herein, wherein a common number of symbols are applied to two PDSCH transmission occasions.

Example 18 includes the method of example 15 or some other example herein, wherein a common starting symbol offset is applied to a last symbol of a first PDSCH transmission occasion and a first symbol of a second PDSCH transmission occasion.

Example 19 includes the method of example 15 or some other example herein, wherein different beams are applied for a plurality of scheduled PDSCHs in different transmission occasions when repetitions are applied for transmission of the scheduled PDSCHs.

Example 20 includes the method of example 15 or some other example herein, wherein the DCI further includes an indication of a first transmission configuration indication (TCI) state for a first transmission occasion of a plurality of scheduled PDSCHs, and a second TCI state for a second transmission occasion of scheduled PDSCHs.

Example 21 includes the method of example 15 or some other example herein, wherein the DCI includes an indication of a first TCI state and a second TCI state applied to repetitions of a PDSCH.

Example 22 includes the method of any of examples 15-21, wherein the method is performed by a next-generation NodeB (gNB) or portion thereof.

Example 23 includes a method of a user equipment (UE) comprising:
receiving, from an next-generation NodeB (gNB), downlink control information (DCI) that includes configuration information for scheduling a plurality of physical downlink shared channel (PDSCH) messages to the UE, wherein a frequency domain resource allocation (FDRA) is allocated for all scheduled PDSCHs for different transmit receive points (TRPs) using a frequency division multiplexing (FDM) scheme, or two repetitions per slot are applied for all scheduled PDSCHs for different TRPs using a time division multiplexing (TDM) scheme; and
receiving, from the gNB, the plurality of PDSCH messages using different receive beams based on the DCI.

Example 24 includes the method of example 23 or some other example herein, wherein the configuration information further includes configuration information for scheduling a plurality of physical uplink shared channel (PUSCH) messages, the method further comprising encoding the plurality of PUSCH messages for transmission using different transmit beams.

Example 25 includes the method of example 23 or some other example herein, wherein a common number of symbols are applied to two PDSCH transmission occasions.

Example 26 includes the method of example 23 or some other example herein, wherein a common starting symbol offset is applied to a last symbol of a first PDSCH transmission occasion and a first symbol of a second PDSCH transmission occasion.

Example 27 includes the method of example 23 or some other example herein, wherein different beams are applied for a plurality of scheduled PDSCHs in different transmission occasions when repetitions are applied for transmission of the scheduled PDSCHs.

Example 28 includes the method of example 23 or some other example herein, wherein the DCI further includes an indication of a first transmission configuration indication (TCI) state for a first transmission occasion of a plurality of scheduled PDSCHs, and a second TCI state for a second transmission occasion of scheduled PDSCHs.

Example 29 includes the method of example 23 or some other example herein, wherein the DCI includes an indication of a first TCI state and a second TCI state applied to repetitions of a PDSCH.

Example X1 may include a method of a user equipment (UE), the method comprising:
receiving, from a gNodeB (gNB), an indication of a type of data transmission for physical uplink shared channel (PUSCH) or physical downlink shared channel (PDSCH); and
transmitting, by UE, the PUSCH in accordance with the indicated type of data transmission; or
receiving, by UE, the PDSCH in accordance with the indicated type of data transmission.

Example X2 may include the method of example X1 or some other example herein, wherein the type of data transmission may include one or more following: Single PDSCH or PUSCH, where each PDSCH or PUSCH is scheduled within a slot; Single PDSCH or PUSCH with repetition, where each PDSCH or PUSCH is scheduled with more than one repetition; Single PDSCH or PUSCH, where each PDSCH or PUSCH spans more than one slot; Multi-PDSCH or multi-PUSCH transmission, where each PDSCH or PUSCH is located within a slot; Multi-PDSCH or multi-PUSCH transmission, where each PDSCH or PUSCH is scheduled with more than one repetition and each repetition is located within a slot; Multi-PDSCH or multi-PUSCH transmission, where each PDSCH or PUSCH carrying a TB spans more than one slot

Example X3 may include the method of example X1 or some other example herein, wherein if a UE is configured to support a subset or all type of the aforementioned type of data transmission, a subset of TDRA lists can be configured for one type of data transmissions.

Example X4 may include the method of example 1 or some other example herein, wherein when UE is scheduled with an entry of the configured TDRA list, UE can derive the type of data transmission for PDSCH and PUSCH.

Example X5 may include the method of example X1 or some other example herein, wherein indication of one or more of the above type of data transmissions can be configured by higher layers via minimum system information (MSI), remaining minimum system information (RMSI), other system information (OSI) or dedicated radio resource control (RRC) signalling or indicated in the DCI or a combination thereof.

Example X6 may include the method of example X1 or some other example herein, wherein for each entry of TDRA list, one or more parameters for TDRA can be commonly applied for all the scheduled PDSCHs or PUSCHs, while the remaining parameters for TDRA can be independently configured for different scheduled PDSCHs or PUSCHs.

Example X7 may include the method of example X1 or some other example herein, wherein the parameters for TDRA may include k0 or k2; mapping type; SLIV for each scheduled PDSCH or PUSCH in a slot; number of repetitions for each scheduled PDSCH or PUSCH if repetition is applied for the transmission of PDSCH or PUSCH; number of slots for each scheduled PDSCH or PUSCH if each PDSCH or PUSCH carrying a TB spans more than one slot.

Example X8 may include the method of example X1 or some other example herein, wherein if only one PDSCH or PUSCH is scheduled with repetition, a single k0 or k2 and number of repetitions, and same mapping type can be applied for the scheduled PDSCH or PUSCH, respectively; wherein a list of SLIVs can be applied for scheduled PDSCH repetition or PUSCH repetition.

Example X9 may include the method of example X1 or some other example herein, wherein if repetition is applied for the transmission of more than one PDSCHs or PUSCHs, a single k0 or k2, same mapping type and number of repetitions can be applied for all the scheduled PDSCHs or PUSCHs, respectively; consecutive SLIV may be allocated for PDSCH or PUSCH repetition.

Example X10 may include the method of example X1 or some other example herein, wherein a list of SLIVs can be applied for scheduled PDSCHs or PUSCHs, where a first SLIV is allocated for the first PDSCH or PUSCH with repetitions, a second SLIV is allocated for the second PDSCH or PUSCH with repetitions

Example X11 may include the method of example X1 or some other example herein, wherein if repetition is applied for the transmission of PDSCHs or PUSCHs, a single k0 or k2, and same mapping type can be applied for scheduled PDSCHs or PUSCH, respectively, wherein a list of {SLIV, number of repetitions} can be applied for scheduled PDSCHs or PUSCHs.

Example X12 may include the method of example X1 or some other example herein, wherein if each PDSCH or PUSCH carrying a TB spans more than one slot, a single k0 or k2 and same mapping type can be applied for scheduled PDSCHs or PUSCH, respectively, wherein a list of {SLIV, number of slots} can be applied for scheduled PDSCHs or PUSCHs,

Example X13 may include the method of example X1 or some other example herein, wherein for each entry of TDRA list, all parameters for TDRA can be independently configured for different scheduled PDSCHs or PUSCHs.

Example X14 may include the method of example XX1 or some other example herein, wherein for each entry of TDRA list, if repetition is applied for each scheduled PDSCH, a list of {k0, mapping type, SLIV, number of repetitions} can be applied for scheduled PDSCHs.

Example X15 may include a method of a user equipment (UE), the method comprising:
receiving an indication of a type of a data transmission for a physical uplink shared channel (PUSCH) or a physical downlink shared channel (PDSCH); and
encoding the PUSCH for transmission based on the indicated type of data transmission; or
receiving the PDSCH based on the indicated type of data transmission.

Example X16 may include the method of example X15 or some other example herein, wherein the type of data transmission includes one or more of: a single PDSCH or PUSCH scheduled within a slot; a single PDSCH or PUSCH with repetition; a single PDSCH or PUSCH that spans more than one slot; a multi-PDSCH or multi-PUSCH transmission, wherein each PDSCH or PUSCH is located within a slot; a multi-PDSCH or multi-PUSCH transmission, wherein each PDSCH or PUSCH is scheduled with more than one repetition and each repetition is located within a slot; a multi-PDSCH or multi-PUSCH transmission, wherein each PDSCH or PUSCH carrying a TB spans more than one slot.

Example X17 may include the method of examples X15-X16 or some other example herein, further comprising receiving configuration information for a subset of TDRA lists configured for the type of data transmission.

Example X18 may include the method of example X15-X17 or some other example herein, further comprising receiving a DCI to schedule the data transmission, wherein the indication of the type of data transmission includes an entry of a configured TDRA list in the DCI.

Example Y1 includes an apparatus comprising:
memory to store time domain resource allocation (TDRA) information associated with data transmission; and
processing circuitry, coupled with the memory, to:
   retrieve the TDRA information from the memory, wherein the TDRA information includes a plurality of TDRA parameters that are independently configured for different scheduled data transmissions; and
   encode a message for transmission to a user equipment (UE) that includes the TDRA information.

Example Y2 includes the apparatus of example Yl or some other example herein, wherein the scheduled data transmissions include:
a single physical downlink shared channel (PDSCH) or physical uplink shared channel (PUSCH) transmission, where each PDSCH or PUSCH transmission is scheduled within a slot;
a single PDSCH transmission or PUSCH transmission with repetition, where each PDSCH or PUSCH transmission is scheduled with more than one repetition; or
a single PDSCH or PUSCH transmission, where each PDSCH or PUSCH transmission spans more than one slot.

Example Y3 includes the apparatus of example Y2 or some other example herein, wherein only one PDSCH or PUSCH is scheduled with repetition, and wherein: a single slot offset between downlink control information (DCI) and the scheduled PDSCH or PUSCH is applied to the scheduled data transmission, a common mapping type is applied to the scheduled PDSCH or PUSCH, and a list of starting and length indicator values (SLIVs) are applied for scheduled PDSCH repetitions or PUSCH repetitions.

Example Y4 includes the apparatus of example Y1 or some other example herein, wherein the scheduled data transmissions include:
a multi-PDSCH or multi-PUSCH transmission, where each PDSCH or PUSCH transmission is located within a slot;
a multi-PDSCH or multi-PUSCH transmission, where each PDSCH or PUSCH transmission is scheduled with more than one repetition and each repetition is located within a slot; or
a multi-PDSCH or multi-PUSCH transmission, where each PDSCH or PUSCH transmission carrying a transport block (TB) spans more than one slot.

Example Y5 includes the apparatus of example Y1 or some other example herein, wherein repetition is applied to transmission of a plurality of PDSCHs or PUSCHs, and wherein: a single slot offset between downlink control information (DCI) a scheduled PDSCH or PUSCH is applied for all scheduled PDSCHs or PUSCHs, a common mapping type and number of repetitions are applied for all the scheduled PDSCHs or PUSCHs, and consecutive SLIVs are allocated for PDSCH or PUSCH repetitions.

Example Y6 includes the apparatus of example Y1 or some other example herein, wherein the TDRA information includes a list entry to indicate to the UE a type of data transmission for PDSCH or PUSCH.

Example Y7 includes the apparatus of example Y1 or some other example herein, wherein the message is encoded for transmission via minimum system information (MSI), remaining minimum system information (RMSI), other system information (OSI) or dedicated radio resource control (RRC) signaling.

Example Y8 includes the apparatus of any of examples Y1-Y7 or some other example herein, wherein the plurality of TDRA parameters include an indication of: a slot offset between downlink control information (DCI) and each scheduled PDSCH, a slot offset between DCI and each scheduled PUSCH, a mapping type of each scheduled PDSCH or PUSCH, a starting and length indicator value (SLIV) for each scheduled PDSCH or PUSCH in a slot, a number of repetitions for each scheduled PDSCH or PUSCH, or a number of slots for each scheduled PDSCH or PUSCH.

Example Y9 includes one or more computer-readable media storing instructions that, when executed by one or more processors, cause a next-generation NodeB (gNB) to:
determine time domain resource allocation (TDRA) information associated with data transmission, wherein the TDRA information includes a plurality of TDRA parameters that are independently configured for different scheduled data transmissions; and
encode a message for transmission to a user equipment (UE) that includes the TDRA information.

Example Y10 includes the one or more computer-readable media of example Y9 or some other example herein, wherein the scheduled data transmissions include:
a single physical downlink shared channel (PDSCH) or physical uplink shared channel (PUSCH) transmission, where each PDSCH or PUSCH transmission is scheduled within a slot;
a single PDSCH transmission or PUSCH transmission with repetition, where each PDSCH or PUSCH transmission is scheduled with more than one repetition; or
a single PDSCH or PUSCH transmission, where each PDSCH or PUSCH transmission spans more than one slot.

Example Y11 includes the one or more computer-readable media of example Y10 or some other example herein, wherein only one PDSCH or PUSCH is scheduled with repetition, and wherein: a single slot offset between downlink control information (DCI) and the scheduled PDSCH or PUSCH is applied to the scheduled data transmission, a common mapping type is applied to the scheduled PDSCH or PUSCH, and a list of starting and length indicator values (SLIVs) are applied for scheduled PDSCH repetitions or PUSCH repetitions.

Example Y12 includes the one or more computer-readable media of example Y9 or some other example herein, wherein the scheduled data transmissions include:
a multi-PDSCH or multi-PUSCH transmission, where each PDSCH or PUSCH transmission is located within a slot;
a multi-PDSCH or multi-PUSCH transmission, where each PDSCH or PUSCH transmission is scheduled with more than one repetition and each repetition is located within a slot; or
a multi-PDSCH or multi-PUSCH transmission, where each PDSCH or PUSCH transmission carrying a transport block (TB) spans more than one slot.

Example Y13 includes the one or more computer-readable media of example Y9 or some other example herein, wherein repetition is applied to transmission of a plurality of PDSCHs or PUSCHs, and wherein: a single slot offset between downlink control information (DCI) a scheduled PDSCH or PUSCH is applied for all scheduled PDSCHs or PUSCHs, a common mapping type and number of repetitions are applied for all the scheduled PDSCHs or PUSCHs, and consecutive SLIVs are allocated for PDSCH or PUSCH repetitions.

Example Y14 includes the one or more computer-readable media of example Y9 or some other example herein, wherein the TDRA information includes a list entry to indicate to the UE a type of data transmission for PDSCH or PUSCH.

Example Y15 includes the one or more computer-readable media of example Y9 or some other example herein, wherein the message is encoded for transmission via minimum system information (MSI), remaining minimum system information (RMSI), other system information (OSI) or dedicated radio resource control (RRC) signaling.

Example Y16 includes the one or more computer-readable media of any of examples Y9-Y15 or some other example herein, wherein the plurality of TDRA parameters include an indication of: a slot offset between downlink control information (DCI) and each scheduled PDSCH, a slot offset between DCI and each scheduled PUSCH, a mapping type of each scheduled PDSCH or PUSCH, a starting and length indicator value (SLIV) for each scheduled PDSCH or PUSCH in a slot, a number of repetitions for each scheduled PDSCH or PUSCH, or a number of slots for each scheduled PDSCH or PUSCH.

Example Y17 includes one or more computer-readable media storing instructions that, when executed by one or more processors, cause a user equipment (UE) to:
receive a message that includes time domain resource allocation (TDRA) information associated with data transmission, wherein the TDRA information includes a plurality of TDRA parameters that are independently configured for different scheduled data transmissions; and
prepare a scheduled data transmission for transmission to a next-generation NodeB (gNB) based on the TDRA information, or receive a scheduled data transmission from the gNB based on the TDRA information.

Example Y18 includes the one or more computer-readable media of example Y17 or some other example herein, wherein the scheduled data transmissions include:
a single physical downlink shared channel (PDSCH) or physical uplink shared channel (PUSCH) transmission, where each PDSCH or PUSCH transmission is scheduled within a slot;
a single PDSCH transmission or PUSCH transmission with repetition, where each PDSCH or PUSCH transmission is scheduled with more than one repetition; or
a single PDSCH or PUSCH transmission, where each PDSCH or PUSCH transmission spans more than one slot.

Example Y19 includes the one or more computer-readable media of example Y18 or some other example herein, wherein only one PDSCH or PUSCH is scheduled with repetition, and wherein: a single slot offset between downlink control information (DCI) and the scheduled PDSCH or PUSCH is applied to the scheduled data transmission, a common mapping type is applied to the scheduled PDSCH or PUSCH, and a list of starting and length indicator values (SLIVs) are applied for scheduled PDSCH repetitions or PUSCH repetitions.

Example Y20 includes the one or more computer-readable media of example Y17 or some other example herein, wherein the scheduled data transmissions include:
a multi-PDSCH or multi-PUSCH transmission, where each PDSCH or PUSCH transmission is located within a slot;
a multi-PDSCH or multi-PUSCH transmission, where each PDSCH or PUSCH transmission is scheduled with more than one repetition and each repetition is located within a slot; or
a multi-PDSCH or multi-PUSCH transmission, where each PDSCH or PUSCH transmission carrying a transport block (TB) spans more than one slot.

Example Y21 includes the one or more computer-readable media of example Y17 or some other example herein, wherein repetition is applied to transmission of a plurality of PDSCHs or PUSCHs, and wherein: a single slot offset between downlink control information (DCI) a scheduled PDSCH or PUSCH is applied for all scheduled PDSCHs or PUSCHs, a common mapping type and number of repetitions are applied for all the scheduled PDSCHs or PUSCHs, and consecutive SLIVs are allocated for PDSCH or PUSCH repetitions.

Example Y22 includes the one or more computer-readable media of example Y17 or some other example herein, wherein the TDRA information includes a list entry to indicate to the UE a type of data transmission for PDSCH or PUSCH.

Example Y23 includes the one or more computer-readable media of example Y17 or some other example herein, wherein the message is encoded for transmission via minimum system information (MSI), remaining minimum system information (RMSI), other system information (OSI) or dedicated radio resource control (RRC) signaling.

Example Y24 includes the one or more computer-readable media of any of examples Y17-Y23 or some other example herein, wherein the plurality of TDRA parameters include an indication of: a slot offset between downlink control information (DCI) and each scheduled PDSCH, a slot offset between DCI and each scheduled PUSCH, a mapping type of each scheduled PDSCH or PUSCH, a starting and length indicator value (SLIV) for each scheduled PDSCH or PUSCH in a slot, a number of repetitions for each scheduled PDSCH or PUSCH, or a number of slots for each scheduled PDSCH or PUSCH.

Example Z01 may include an apparatus comprising means to perform one or more elements of a method described in or related to any of examples 1-Y24, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1- Y24, or any other method or process described herein.

Example Z03 may include an apparatus comprising logic, modules, or circuitry to perform one or more elements of a method described in or related to any of examples 1- Y24, or any other method or process described herein.

Example Z04 may include a method, technique, or process as described in or related to any of examples 1- Y24, or portions or parts thereof.

Example ZO5 may include an apparatus comprising: one or more processors and one or more computer-readable media comprising instructions that, when executed by the one or more processors, cause the one or more processors to perform the method, techniques, or process as described in or related to any of examples 1- Y24, or portions thereof.

Example Z06 may include a signal as described in or related to any of examples 1- Y24, or portions or parts thereof.

Example Z07 may include a datagram, packet, frame, segment, protocol data unit (PDU), or message as described in or related to any of examples 1- Y24, or portions or parts thereof, or otherwise described in the present disclosure.

Example Z08 may include a signal encoded with data as described in or related to any of examples 1-18, or portions or parts thereof, or otherwise described in the present disclosure.

Example Z09 may include a signal encoded with a datagram, packet, frame, segment, protocol data unit (PDU), or message as described in or related to any of examples 1- Y24, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1- Y24, or portions thereof.

Example Z11 may include a computer program comprising instructions, wherein execution of the program by a processing element is to cause the processing element to carry out the method, techniques, or process as described in or related to any of examples 1- Y24, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| COMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, CSI-RS |
| | Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, | Demodulation Reference Signal |
| DMRS | |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further |
| | enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access |
| | Network |
| GGSN | Gateway GPRS Support Node |
| GLONASS | GLObal'naya NAvigatsionnaya Sputnikovaya Sistema |
| | (Engl.: Global Navigation Satellite System) |
| gNB | Next Generation NodeB |
| gNB-CU | gNB-centralized unit, Next Generation NodeB |
| | centralized unit |
| gNB-DU | gNB-distributed unit, Next Generation NodeB |
| | distributed unit |
| GNSS | Global Navigation Satellite System |
| GPRS | General Packet Radio Service |
| GPSI | Generic Public Subscription Identifier |
| GSM | Global System for Mobile Communications, Groupe |
| | Special Mobile |
| GTP | GPRS Tunneling Protocol |
| GTP-UGPRS | Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure |
| | (https is http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IM | Interference Measurement, Intermodulation, |
| IP | Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key kB |
| | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network 90 layer) |
| LAA | Licensed Assisted Access |
| LAN | Local Area Network |
| LADN | Local Area Data Network |
| LBT | Listen Before Talk |
| LCM | LifeCycle 100 Management |
| LCR | Low Chip Rate |
| LCS | Location Services |
| LCID | Logical Channel ID |
| LI | Layer Indicator |
| LLC | Logical Link Control, Low Layer Compatibility |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec |
| | Tunnel |
| LTE | Long Term Evolution |
| M2M | Machine-to-Machine |
| MAC | Medium Access Control (protocol layering context) |
| | MAC Message authentication code (security/ |
| | encryption context) |
| MAC-A | MAC used for authentication and key agreement |
| | (TSG T WG3 context) MAC-IMAC used for data |
| | integrity of 40 signalling messages (TSG T WG3 |
| | context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management |
| | Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications mMTCmassive MTC, |
| | massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non- Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame |
| | timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH Block | SS/PBCH Block Resource Indicator, Synchronization |
| SSBRI | Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over- Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | extensible Markup Language |
| XRES | EXpected user RESponse |
| XOR | exclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-24. (canceled)

25. An apparatus comprising:
memory to store time domain resource allocation (TDRA) information associated with data transmission; and
processing circuitry, coupled with the memory, to:
retrieve the TDRA information from the memory, wherein the TDRA information includes a plurality of TDRA parameters that are independently configured for different scheduled data transmissions; and
encode a message for transmission to a user equipment (UE) that includes the TDRA information.

26. The apparatus of claim 25, wherein the scheduled data transmissions include:
a single physical downlink shared channel (PDSCH) or physical uplink shared channel (PUSCH) transmission, where each PDSCH or PUSCH transmission is scheduled within a slot;
a single PDSCH transmission or PUSCH transmission with repetition, where each PDSCH or PUSCH transmission is scheduled with more than one repetition; or
a single PDSCH or PUSCH transmission, where each PDSCH or PUSCH transmission spans more than one slot.

27. The apparatus of claim 26, wherein only one PDSCH or PUSCH is scheduled with repetition, and wherein: a single slot offset between downlink control information (DCI) and the scheduled PDSCH or PUSCH is applied to the scheduled data transmission, a common mapping type is applied to the scheduled PDSCH or PUSCH, and a list of starting and length indicator values (SLIVs) are applied for scheduled PDSCH repetitions or PUSCH repetitions.

28. The apparatus of claim 25, wherein the scheduled data transmissions include:
a multi-PDSCH or multi-PUSCH transmission, where each PDSCH or PUSCH transmission is located within a slot;
a multi-PDSCH or multi-PUSCH transmission, where each PDSCH or PUSCH transmission is scheduled with more than one repetition and each repetition is located within a slot; or
a multi-PDSCH or multi-PUSCH transmission, where each PDSCH or PUSCH transmission carrying a transport block (TB) spans more than one slot.

29. The apparatus of claim 25, wherein repetition is applied to transmission of a plurality of PDSCHs or PUSCHs, and wherein: a single slot offset between downlink control information (DCI) a scheduled PDSCH or PUSCH is applied for all scheduled PDSCHs or PUSCHs, a common mapping type and number of repetitions are applied for all the scheduled PDSCHs or PUSCHs, and consecutive SLIVs are allocated for PDSCH or PUSCH repetitions.

30. The apparatus of claim 25, wherein the TDRA information includes a list entry to indicate to the UE a type of data transmission for PDSCH or PUSCH.

31. The apparatus of claim 25, wherein the message is encoded for transmission via minimum system information (MSI), remaining minimum system information (RMSI), other system information (OSI) or dedicated radio resource control (RRC) signaling.

32. The apparatus of claim 25, wherein the plurality of TDRA parameters include an indication of: a slot offset between downlink control information (DCI) and each scheduled PDSCH, a slot offset between DCI and each scheduled PUSCH, a mapping type of each scheduled PDSCH or PUSCH, a starting and length indicator value (SLIV) for each scheduled PDSCH or PUSCH in a slot, a number of repetitions for each scheduled PDSCH or PUSCH, or a number of slots for each scheduled PDSCH or PUSCH.

33. One or more computer-readable media storing instructions that, when executed by one or more processors, cause a next-generation NodeB (gNB) to:
determine time domain resource allocation (TDRA) information associated with data transmission, wherein the TDRA information includes a plurality of TDRA parameters that are independently configured for different scheduled data transmissions; and
encode a message for transmission to a user equipment (UE) that includes the TDRA information.

34. The one or more computer-readable media of claim 33, wherein the scheduled data transmissions include:
a single physical downlink shared channel (PDSCH) or physical uplink shared channel (PUSCH) transmission, where each PDSCH or PUSCH transmission is scheduled within a slot;
a single PDSCH transmission or PUSCH transmission with repetition, where each PDSCH or PUSCH transmission is scheduled with more than one repetition; or
a single PDSCH or PUSCH transmission, where each PDSCH or PUSCH transmission spans more than one slot.

35. The one or more computer-readable media of claim 34, wherein only one PDSCH or PUSCH is scheduled with repetition, and wherein: a single slot offset between downlink control information (DCI) and the scheduled PDSCH or PUSCH is applied to the scheduled data transmission, a common mapping type is applied to the scheduled PDSCH or PUSCH, and a list of starting and length indicator values (SLIVs) are applied for scheduled PDSCH repetitions or PUSCH repetitions.

36. The one or more computer-readable media of claim 33, wherein the scheduled data transmissions include:
a multi-PDSCH or multi-PUSCH transmission, where each PDSCH or PUSCH transmission is located within a slot;
a multi-PDSCH or multi-PUSCH transmission, where each PDSCH or PUSCH transmission is scheduled with more than one repetition and each repetition is located within a slot; or
a multi-PDSCH or multi-PUSCH transmission, where each PDSCH or PUSCH transmission carrying a transport block (TB) spans more than one slot.

37. The one or more computer-readable media of claim 33, wherein repetition is applied to transmission of a plurality of PDSCHs or PUSCHs, and wherein: a single slot offset between downlink control information (DCI) a scheduled PDSCH or PUSCH is applied for all scheduled PDSCHs or PUSCHs, a common mapping type and number of repetitions are applied for all the scheduled PDSCHs or PUSCHs, and consecutive SLIVs are allocated for PDSCH or PUSCH repetitions.

38. The one or more computer-readable media of claim 33, wherein the TDRA information includes a list entry to indicate to the UE a type of data transmission for PDSCH or PUSCH.

39. The one or more computer-readable media of claim 33, wherein the message is encoded for transmission via minimum system information (MSI), remaining minimum system information (RMSI), other system information (OSI) or dedicated radio resource control (RRC) signaling.

40. The one or more computer-readable media of claim 33, wherein the plurality of TDRA parameters include an indication of: a slot offset between downlink control information (DCI) and each scheduled PDSCH, a slot offset between DCI and each scheduled PUSCH, a mapping type for each scheduled PDSCH or PUSCH; a starting and length indicator value (SLIV) for each scheduled PDSCH or PUSCH in a slot, a number of repetitions for each scheduled PDSCH or PUSCH, or a number of slots for each scheduled PDSCH or PUSCH.

41. One or more computer-readable media storing instructions that, when executed by one or more processors, cause a user equipment (UE) to:
identify a received message that includes time domain resource allocation (TDRA) information associated with data transmission, wherein the TDRA information includes a plurality of TDRA parameters that are independently configured for different scheduled data transmissions; and
prepare a scheduled data transmission for transmission to a next-generation NodeB (gNB) based on the TDRA information, or receive a scheduled data transmission from the gNB based on the TDRA information.

42. The one or more computer-readable media of claim 41, wherein the scheduled data transmissions include:
a single physical downlink shared channel (PDSCH) or physical uplink shared channel (PUSCH) transmission, where each PDSCH or PUSCH transmission is scheduled within a slot;
a single PDSCH transmission or PUSCH transmission with repetition, where each PDSCH or PUSCH transmission is scheduled with more than one repetition; or
a single PDSCH or PUSCH transmission, where each PDSCH or PUSCH transmission spans more than one slot.

43. The one or more computer-readable media of claim 41, wherein the scheduled data transmissions include:
a multi-PDSCH or multi-PUSCH transmission, where each PDSCH or PUSCH transmission is located within a slot;
a multi-PDSCH or multi-PUSCH transmission, where each PDSCH or PUSCH transmission is scheduled with more than one repetition and each repetition is located within a slot; or
a multi-PDSCH or multi-PUSCH transmission, where each PDSCH or PUSCH transmission carrying a transport block (TB) spans more than one slot.

44. The one or more computer-readable media of claim 41, wherein repetition is applied to transmission of a plurality of PDSCHs or PUSCHs, and wherein: a single slot offset between downlink control information (DCI) a scheduled PDSCH or PUSCH is applied for all scheduled PDSCHs or PUSCHs, a common mapping type and number of repetitions are applied for all the scheduled PDSCHs or PUSCHs, and consecutive SLIVs are allocated for PDSCH or PUSCH repetitions.
